(19) United States
(12) Patent Application Publication
(10) Pub. No.: US 2025/0071080 A1
(43) Pub. Date: Feb. 27, 2025

(54) MESSAGED VALUE RETRIEVAL AND MANAGEMENT SYSTEM AND METHOD OF USE

(71) Applicant: Keith Eric Petri, Woodstock, NY (US)

(72) Inventor: Keith Eric Petri, Woodstock, NY (US)

(21) Appl. No.: 18/816,883

(22) Filed: Aug. 27, 2024

Related U.S. Application Data
(60) Provisional application No. 63/579,030, filed on Aug. 27, 2023.

(51) Int. Cl. H04L 51/212; H04L 51/42

(52) U.S. Cl. CPC H04L 51/212; H04L 51/42

(57) ABSTRACT

A computer implemented messaged value retrieval and management system that can include an off-account filter service operable to perform content distribution control using mechanisms such as off-account content filtering, the off-account content filtering including one or more configurable filters. In some embodiments, the computer implemented messaged value retrieval and management system includes an off-account messaged distribution service operable to distribute email messages. In some embodiments, the computer implemented messaged value retrieval and management system includes an off-account message collection service operable to collect email messages.

### CROSS-REFERENCE TO RELATED APPLICATIONS

This application claims priority through the applicant's prior U.S. Provisional Patent Application No. 63/579,030 entitled “MESSAGED VALUE RETRIEVAL AND MANAGEMENT SYSTEM AND METHOD OF USE” filed on Aug. 27, 2023, this application further being a continuation-in-part of U.S. Non-Provisional patent application Ser. No. 17/240,362 entitled “MESSAGED VALUE RETRIEVAL SYSTEM AND METHOD OF USE” filed on Apr. 26, 2021, which claims priority through the applicant's prior U.S. Provisional Patent Application No. 63/014,987 entitled “IDENTITY MANAGEMENT COMMUNICATION FILTERING SYSTEM AND METHOD” filed on Apr. 24, 2020, which applications are hereby incorporated by reference in their entirety.

### COPYRIGHT

This patent document contains material subject to copyright protection. The copyright owner has no objection to the photocopy reproduction of the patent document or the patent disclosure in exactly the form it appears in the Patent and Trademark Office patent file or records, but otherwise reserves all copyright rights.

### TECHNICAL FIELD

The present application relates to the technical field of messaging, and more particularly, to a computer implemented system and method that improves one or more of managing, blocking, and filtering of incoming messages.

### BACKGROUND ART

With the emergence and evolution of digital communications technologies came an increasing and unmanageable volume of unwanted or hard to filter messaged content. Included in this was an increased volume of messaged value items, such as offers of value. This included, for example, product or service discounts, credits, and the like. Traditional email became one of the dominant methods for product and service providers to introduce potential purchasers to and promote their brands, including through advertising that included text, graphics, media, attachments, rich content generally, and offers of value.

As the volume of such emails exploded, consumers were left with overloaded email inboxes, the management of which became a burden to the receiver, the local devices storing the emails, and the email platforms delivering and retaining the emails. This deluge of emails made it difficult, impractical, or both, for receivers to take advantage of the messaged value items as they approached purchasing moments where the messaged value might otherwise apply.

The disadvantages of in-account management of messaged value were many. Without specific services to manage messaged value items, account clutter and corresponding memory demands exploded, annoying the receiver, slowing down email processes, increasing memory demands on computing devices, and increasing bandwidth usage. Email, which began as an improvement to asynchronous communication methods, evolved into a noisy quagmire of every kind of content. Further, it sometimes became prohibitively burdensome to identify and redeem offers of value.

The receipt of superfluous marketing and advertising content introduced security risks. The introduction of rich content such as, for example, html-based email content, embedded javascript, embedded rich content such as media files, flash content, and attachments, all increased the potential and occurrence of spyware and malware making it the last mile to a device. This introduced a market for email scanning technologies which impacted the cost of email broadly, both for service providers and users. This further increased the scanning demands for malware scanning technologies generally.

In the event up front scanning did not occur and users wanted to review received messaged content for value, interest, and relevance, this typically involved their partially or fully accessing the messaged content, which provided further availability of device and data access to potentially malicious code or attachments. In addition, many of these rich content marketing and advertising elements employed tracking mechanisms and technologies that the user knew nothing about, would prefer not to engage with, or both.

A further security and privacy problem arose when services had access to the user's account or authentication credentials. Scanning and searching of on-account stored emails had the potential of compromising security and privacy of the individuals engaged in unrelated email communication activity. For some professional users, even the existence of potential compromises introduced unacceptable levels of risk, such as for those wishing to take reasonable precautions to protect their trade secrets or privilege communications.

Difficulties associated with discovering, retrieving, and applying messaged value items were many. First, the large volume of emails generally, along with the amount of rich content included in messaged offers of value themselves, typically made identifying value of interest, both in real time and the time of purchase, impractical. Further, whether or not a particular offer of value was applicable to a particular product, whether it was still valid, whether it was of an amount that was of interest, or whether it had other conditions connected to the recognition of the value was hard to discern, difficult to keep track of over time, and particularly difficult to ascertain at the moment of purchase. Often, a user would first loosely recall having seen some sort of an offer for value at some time in the past. Then they would try to search their email, which could return a large number of unrelated email items. Then they would scroll through the items trying to find the messaged value item, open the email, and wade through the content trying to find the value. Then they would determine if it applied and was valid, if they could. In some cases, they would have to enter a code manually into a purchasing interface to determine if the offer was still valid. These were often a prohibitively burdensome series of steps dissuading the purchaser from bothering to engage in obtaining the value offered, resulting in the purchaser many times paying more for a purchase than they would have otherwise had the messaged value item been identifiable, retrievable, and more easily applied.

Both the technical and economic problems with these prior approaches often resulted in, among other things, increased costs to providers and purchasers, reduced levels of security and privacy, and increased consumer burdens with respect to managing emails and messaged value items.

### SUMMARY OF SOME ASPECTS OF THE PRESENT

### System and Methods

The applicants believe that they have discovered at least one or more of the problems and issues with systems and methods of traditional approaches, as well as advantages variously provided by differing embodiments of the messaged value retrieval and management system and method of use disclosed in this specification.

In some embodiments, one or more off-account message and messaged value services provide one or more of message management services, messaged value services. This set of service can include one or more of a message collection, message parsing, messaged value detection, messaged value categorization, messaged value retention, and messaged value retrieval. In some implementations, a messaged value applicability component is communicatively coupled to the one or more off-account messaged value services, and monitors one or more activities of a device or application, facilitating one or more of determining whether a particular activity, event, and the presence of a detectible element or attribute is suggestive of the possible applicability of a messaged value to a potential event, such as a purchase event.

In certain implementation, one or more off-account message and messaged value services offer one more advantages and benefits to the email provider, the receiver, and their respective devices, network, and infrastructure. Message account clutter can be reduced through, at least in part, limiting delivery of certain messages, content, or both, while making messaged value available to the receiver. This can provide one or more benefits, including but not limited to, reducing memory demands at, for example, an email provider, a receiver device, or both, improving the receivers messaging and communication experience, increasing the speed and efficiency of message processing, and decreasing overall bandwidth usage.

In some instances, the reduction of superfluous marketing and advertising content arriving or residing in a receiver's account, particular on-device, can improve device and data security. This can reduce one or more of the reliance on, dependency on, and cost associated with implementing malware scanning and prevention technologies. Simplified message and messaged content review interfaces can allow receivers to more quickly, and more securely, review content to determine whether or not they wish to allow the content to be distributed to one or more of their accounts. Further, the holding back of these messages and messaged content can reduce the intrusiveness of typical message-embedded tracking technologies, and can otherwise allow receivers to selectively control to which email account such messages can be distributed.

A further security and privacy advantage provided by the messaged value retrieval and management system and method of use can result from the off-account message management, reducing or eliminating the disclosure, retention, or both of receivers account credentials and receiver account access. This can further increase privacy protection, reducing access to private messages and content of senders and receivers. In some embodiments, the messaged value retrieval and management system has no access to an email destination account, avoiding the expansion of access points or visibility of emails generally.

In some implementations, one or more of the messaged value management services improve one or more of the ease, efficiency, accuracy, and timeliness of identifying value of interest, including in real time, at the time of purchase, or both. A messaged value parsing service, in combination with one or more of a messaged value detection service, a messaged value categorization service, and a messaged value retention service can provide detection, filtering categorization, and storage of messaged value. This can include, for example, making determinations with respect to associations with products of interest, offer validity, amount thresholds, offer conditions, number of uses allowed, transferability, and the like.

In some instances, a combination of the value management services further includes a value retrieval service that, in combination with other services, is able to retrieve previously-detected, categorized, and retained message value. This can remove the manual burden of receivers performing ad-hoc email searches in an attempt to hopefully discover valid and applicable messaged value items. In some embodiments, one or more of the value management services performs one or more validation checks in advance of the value retrieval service providing messaged value to a requestor, such as a messaged value application component. This can provide benefit to the purchaser in the form of delivering timely, applicable, valid messaged value at or near a moment of purchase, reducing the cost of purchases to the purchaser.

In some implementations, a messaged value application component operates on a purchaser device, monitoring one or more of purchaser or device activities or events, optionally displaying applicable messaged value items, and automatically applying selected message value items, such as through automated form completion, entry of an offer code, or both. In some embodiments, a retrieved message value item includes a code that can be automatically validated by the messaged value application component, such as by interfacing with a code verification service, entering the code into a form field and checking for submissions errors, or both. In some instances, the messaged value application component can respond to receiving an invalid code or offer error by traversing through a list of available and applicable offers of messaged value items until a valid messaged value item is applied and successfully submitted.

Both the technical and economic problems with these prior approaches often resulted in, among other things, increased costs to providers and purchasers, reduced levels of security and privacy, and increased consumer burdens with respect to managing emails and messaged value items.

It is to be understood that this Summary recites some aspects of the present disclosure, but there are other novel and advantageous aspects disclosed in this specification. They will become apparent as this specification proceeds. In this regard, the scope of the invention is to be determined by the claims as issued and not by whether a claim addresses any or all issues noted in the Background or includes a feature included or not included in this Summary.

In some aspects, the techniques described herein relate to a computer implemented messaged value retrieval and management system including in combination: (i) a computing system including at least one server including: (a) at least one processor; (b) at least one computer memory; (c) at least one network interface; and (ii) an off-account filter service at the at least one server operable to perform content distribution control using off-account content filtering, the off-account content filtering including one or more configurable filters.

In some aspects, the techniques described herein relate to a computer implemented messaged value retrieval and management system, wherein the one or more configurable filters includes an order updates filter.

In some aspects, the techniques described herein relate to a computer implemented messaged value retrieval and management system, wherein the one or more configurable filters includes a sponsored content filter.

In some aspects, the techniques described herein relate to a computer implemented messaged value retrieval and management system, wherein the one or more configurable filters includes a limited marketing filter.

In some aspects, the techniques described herein relate to a computer implemented messaged value retrieval and management system, wherein the one or more configurable filters includes a discount filter.

In some aspects, the techniques described herein relate to a computer implemented messaged value retrieval and management system, wherein the one or more configurable filters includes a clearance filter.

In some aspects, the techniques described herein relate to a computer implemented messaged value retrieval and management system, wherein the one or more configurable filters includes a limited release filter.

In some aspects, the techniques described herein relate to a computer implemented messaged value retrieval and management system, wherein the one or more configurable filters includes new arrivals filter.

In some aspects, the techniques described herein relate to a computer implemented messaged value retrieval and management system, wherein the one or more configurable filters includes a back in stock filter.

In some aspects, the techniques described herein relate to a computer implemented messaged value retrieval and management system, wherein the one or more configurable filters includes an events filter.

In some aspects, the techniques described herein relate to a computer implemented messaged value retrieval and management system, wherein the one or more configurable filters includes a trip detail filter.

In some aspects, the techniques described herein relate to a computer implemented messaged value retrieval and management system, wherein the one or more configurable filters includes a socially conscious filter.

In some aspects, the techniques described herein relate to a computer implemented messaged value retrieval and management system, wherein the one or more configurable filters includes a brand filter.

In some aspects, the techniques described herein relate to a computer implemented messaged value retrieval and management system, wherein the one or more configurable filters includes a by item filter.

In some aspects, the techniques described herein relate to a computer implemented messaged value retrieval and management system, wherein the one or more configurable filters includes a by keyword-based filter.

In some aspects, the techniques described herein relate to a computer implemented messaged value retrieval and management system, further including an off-account message collection service operable to collect email messages.

In some aspects, the techniques described herein relate to a computer implemented messaged value retrieval and management system, further including an off-account messaged distribution service operable to distribute email messages.

In some aspects, the techniques described herein relate to a computer implemented messaged value retrieval and management system, further including an off-account message collection service operable to collect email messages.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label. The applicants' preferred and other embodiments are disclosed in the accompanying drawings in which:

FIG. 1 is a block diagram of an architecture supporting the messaged value retrieval and management system, including an example cloud-based, back-end infrastructure;

FIG. 2 is a block diagram of the services and component layers of the messaged value retrieval and management system deployable on the architecture of FIG. 1;

FIG. 3 is a block diagram of the various services, engines, and components of the services and component layers of FIG. 2 performing the various operations of the messaged value retrieval and management system;

FIG. 4 is a flowchart of the various operations and activities performed by the services layers of FIG. 3 in the messaged value retrieval and management system;

FIG. 5 is a flowchart of the messaged value determination operations and activities performed by various services of the services layers of FIG. 3 in the messaged value retrieval and management system;

FIG. 6 is a flowchart of the messaged value item request management operations and activities performed by various services of the services layers of FIG. 3 in the messaged value retrieval and management system;

FIG. 7 is a flowchart of the various operations and activities performed by the messaged value application component of FIG. 3 in the messaged value retrieval and management system;

FIG. 8 is a flowchart of the activity event detection and processing operations and activities performed by the messaged value application component of FIG. 3 in the messaged value retrieval and management system;

FIG. 9 is a flowchart of the application of received messaged value items by the messaged value application component of FIG. 3 in the messaged value retrieval and management system;

FIG. 10 is a block diagram of a computer system suitable for implementing the operations of the messaged value retrieval and management system as part of FIG. 1.

FIG. 11 is a screenshot of an email wrapper interface for a new sender of the messaged value retrieval and management system as part of FIG. 1.

FIG. 12 is a screenshot of an email wrapper interface for a known sender of the messaged value retrieval and management system as part of FIG. 1.

FIG. 13 is a screenshot of an allow sender confirmation following an allow sender event triggered from the email wrapper interface of FIG. 11.

FIG. 14 is a screenshot of a block sender confirmation following a block sender event triggered from the email wrapper interface of FIG. 11.

FIG. 15 is a screenshot of a create filter interface following a create filter event triggered from the email wrapper interface of FIG. 11.

FIG. 16 is a screenshot of an edit destination account interface following an edit destination event triggered from the email wrapper interface of FIG. 11.

FIG. 17 is a screenshot of another edit destination account interface of the dashboard interface of the messaged value retrieval and management system as part of FIG. 1.

FIG. 18 is a screenshot of an emails by account view of the of the messaged value retrieval and management system as part of FIG. 1.

FIG. 19 is a screenshot of another edit destination account interface of the messaged value retrieval and management system as part of FIG. 1.

FIG. 20 is a screenshot of an add destination account interface of the messaged value retrieval and management system as part of FIG. 1.

FIG. 21 is a screenshot of another add destination account interface of the messaged value retrieval and management system as part of FIG. 1.

FIG. 22 is a screenshot of a settings adjustment interface of the messaged value retrieval and management system as part of FIG. 1.

FIG. 23 is a screenshot of a domains configuration interface of the messaged value retrieval and management system as part of FIG. 1.

FIG. 24 is a screenshot of another domains configuration interface of the messaged value retrieval and management system as part of FIG. 1.

FIG. 25 is a screenshot of another domains configuration interface of the messaged value retrieval and management system as part of FIG. 1.

FIG. 26 is a screenshot of another domains configuration interface of the messaged value retrieval and management system as part of FIG. 1.

FIG. 27 is a screenshot of another domains configuration interface of the messaged value retrieval and management system as part of FIG. 1.

FIG. 28 is a screenshot of another domains configuration interface of the messaged value retrieval and management system as part of FIG. 1.

FIG. 29 is a screenshot of another a domains configuration interface of the messaged value retrieval and management system as part of FIG. 1.

FIG. 30 is a screenshot of another domains configuration interface of the messaged value retrieval and management system as part of FIG. 1.

FIG. 31 is a screenshot of another domains configuration interface of the messaged value retrieval and management system as part of FIG. 1.

FIG. 32 is a screenshot of a delivery timing configuration interface of the messaged value retrieval and management system as part of FIG. 1.

FIG. 33 is a screenshot of another delivery timing configuration interface of the messaged value retrieval and management system as part of FIG. 1.

FIG. 34 is a screenshot of another delivery timing configuration interface of the messaged value retrieval and management system as part of FIG. 1.

FIG. 35 is a screenshot of a group creation interface of the messaged value retrieval and management system as part of FIG. 1.

FIG. 36 is a screenshot of a dashboard interface of the messaged value retrieval and management system as part of FIG. 1.

FIG. 37 is a screenshot of a filter library interface of the messaged value retrieval and management system as part of FIG. 1.

FIG. 38 is a screenshot of a discount filter configuration interface of the filter library interface of FIG. 37.

FIG. 39 is a screenshot of a filter configuration interface of the filter library interface of FIG. 37.

FIG. 40 is a screenshot of a custom filter interface of the messaged value retrieval and management system as part of FIG. 1.

FIG. 41 is a screenshot of a filter category interface of the filter library interface of FIG. 37.

FIG. 42 is a screenshot of a digest creation type selection interface of the messaged value retrieval and management system as part of FIG. 1.

FIG. 43 is a screenshot of a digest creation interface of the messaged value retrieval and management system as part of FIG. 1.

FIG. 44 is a screenshot of a group-based digest creation interface of the messaged value retrieval and management system as part of FIG. 1.

FIG. 45 is a screenshot of a set destination interface of the digest creation interface of FIG. 44.

FIG. 46 is a screenshot of a set digest frequency interface of the digest creation interface of FIG. 43.

FIG. 47 is a screenshot of a set digest time of day interface of the digest creation interface of FIG. 43.

FIG. 48 is a screenshot of a set digest duration interface of the digest creation interface of FIG. 43.

FIG. 49 is a screenshot of a digest screen interface of the of the messaged value retrieval and management system as part of FIG. 1.

### DESCRIPTION OF THE PREFERRED AND OTHER EMBODIMENTS

Certain embodiments of the system and methods disclosed are described with reference to methods, apparatus (systems) and computer program products that can be implemented by computer program instructions. These computer program instructions can be provided to a processor of one or more computers, such as a special purpose computer, or other programmable data processing apparatus to produce a machine, such that the instructions, which execute via the processor of the computer or other programmable data processing apparatus, create means for implementing the acts specified herein to transform data from a first state to a second state.

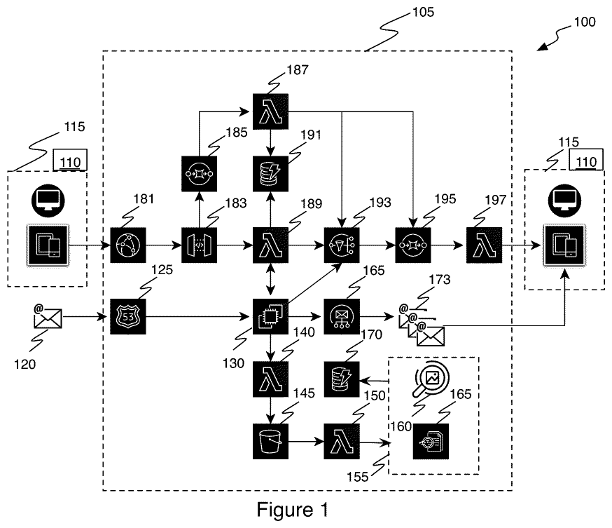

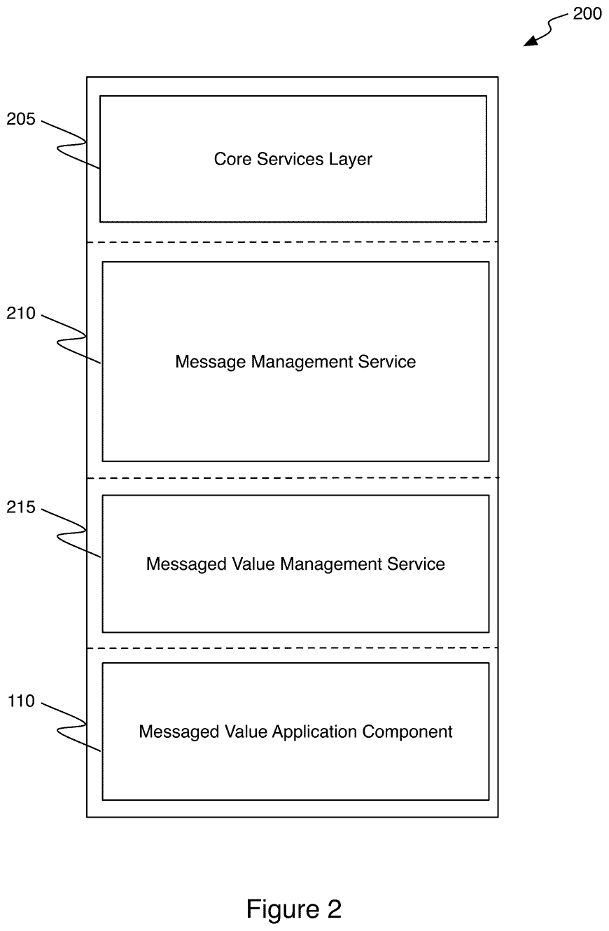

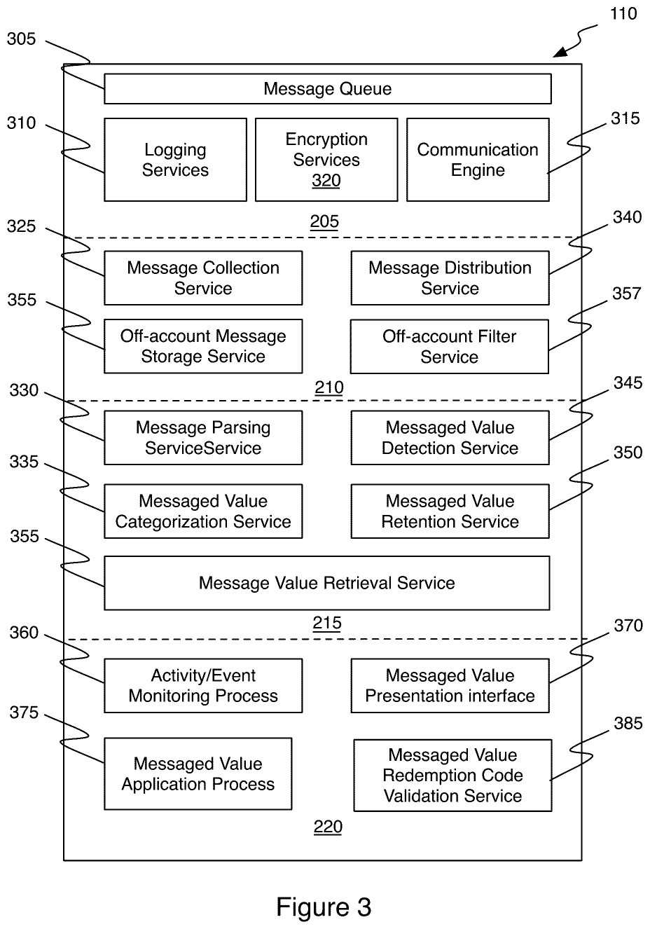

Referring now to FIG. 1, FIG. 2, and FIG. 3, in some instances, the messaged value retrieval and management system runs on an architecture 100 including one or more computing elements and infrastructure services capable of hosting one or more messaged value retrieval and management system services. Email users interact with email clients through devices, such as desktops, laptops, tablets, mobile devices, and the like 115. These devices can typically run various apps and applications, hereinafter referred to collectively as apps, providing various services. In some implementations, a messaged value application component 110 is resident on the device. The messaged value application component can perform one or more messaged value retrieval and management system operations, such as detecting activity events occurring on the device, requesting messaged value items from the messaged value system services 205, 210, 215, receiving messaged value items from the messaged value system services 205, 210, 215, submitting messaged value items to facilitate recognitions of available value, transmitting information about the activity event, messaged value item submission event, and the like to the messaged value system services, and the like. In some embodiments, the messaged value application component 110 is client resident device process, such as a browser extension.

The backend service architecture can be implemented as a cloud infrastructure, such as by using various Amazon Web Services™, Microsoft Azure™, Google Cloud™, and the like, where such cloud infrastructure services run on and are made available form one or more computing devices, including one or more servers. In some embodiments, such as those using one or more of the infrastructure components available with Amazon Web Services™, a domain name service 125 can be configured to direct incoming email 120 to a virtual server instance 130 hosting a mail transfer agent, such as Postfix™. In some embodiments, emails are stored in a binary format on an off-account virtual server instance. In other embodiments, emails are stored in an off-account persistent object storage repository 145, such as Amazon S3™. In some instances, a serverless compute function 150 facilitates the storage of emails in an off-account persistent Amazon S3™ bucket repository 145.

In some implementations, additional lambda compute functions 150 can facilitate delivery of email content to one or more content analysis services, such as a text extraction and text analysis engine 160, an object recognition service 160, and the like. In some instances, these engines and services are part of an infrastructure as a service offering, such as when implementing AWS Textract™. In other instances, services run in a virtual server instance 160. In some instances, the processes running on the virtual server instance 160, serverless compute functions 155, or both, determine the presence of messaged value in at least a messaged content portion, and write the messaged value item and one or more corresponding message value items to an off-account persistent data store 170, such as an off-account relational data store, an off-account NoSQL data store, or the like. In some embodiments, one or more of a serverless compute function, a process running on a virtual server instance 140, or both, integrate with an email sending service 165, such as AWS SES™ for delivery of certain emails containing messaged value 173 and meeting certain predefined criteria or receiving a release message to one or more user email accounts.

In some embodiments, a device component, such as a messaged value application component 110, is communicates with the backend messaged value system services 205, 210, 215, such as through an API gateway 183 via a content delivery network service 181. In some instances, messages received from a requestor are queued for processing in a message queue 185, while in other cases, are processed directly by a service, such as a service including a serverless compute process 189. In certain implementations, the computer processes are in communication with a persistent data store 191 that stores messaged value data items, associated messaged value data items attribute values, or both. Serverless compute functions 187, 189, processes running on virtual server instance 140, or both can direct responses and messaged value item data to devices, including through engagement with notification services 193, additional queues 195, compute functions 197, or both.

It will be understood by a person having ordinary skill in the art that these are but a few of the possible architectures and infrastructures, on which, the messaged value retrieval and management system can be implemented. The various ordering, distribution, and components themselves can be modified in various ways to perform the various operations and obtain desired outcomes.

In some embodiments, one or more engines or services perform the various operations of the messaged value retrieval and management system 200. The core services layer 205 can include, for example, one or more of a message queue 305, which can include support from a messaging service, such as AWS Simple Notification Service™; a logging service 310, which may include support from a governance, compliance, operational auditing, and risk auditing service such as AWS CloudTrail™, and support from a monitoring and management service such as AWS CloudWatch™; an encryption services 320 which may include support from a encryption key management service such as AWS Key Management Service™; and a communication engine 315, which may include support from a content delivery network such as AWS CloudFront, and a managed service for creating, publishing, maintaining, monitoring, and securing APIs at scale, such as AWS API Gateway. The message management service layer 210 can include one or more of a message collection service 325, the message collection service 325 being on-account or off-account, message distribution service 340 operable to distribute messages, the message distribution service 325 being off-account or on-account, such as email messages or content, messaged value content, or both, an off-account message storage service 355, an off-account filter service 357, and one or more of which may include support from a serverless compute service such as AWS Lambda™, processes running on a virtual server instance, such as AWS EC2™, an object storage solution such as Amazon S3™, and a database, such as an AWS DynamoDB™ key-value document database.

In some instance, a messaged value management service layer 215 includes one or more of a message parsing service 330, a messaged value detection service 345, a messaged value categorization service 335, a messaged value retention service 350, and a messaged value retrieval service 355, all of which can include support from one or more of a database, such as an AWS DynamoDB™ key-value document database, a data stream management service, and a messaging service, such as AWS Simple Notification Service™.

In some implementations, a messaged value application component 220 includes one or more of an activity/event monitoring process 360, a messaged value presentation interface 370, a messaged value application process 375, and a messaged value redemption code validation service 385.

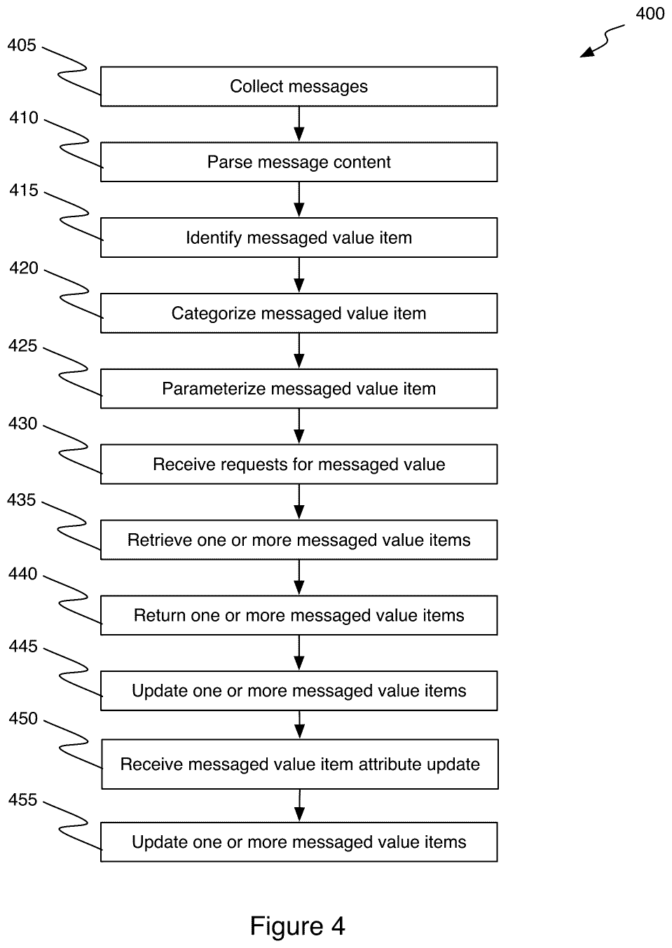

Referring now to FIG. 4, in some embodiments, the messaged value retrieval and management system services can be configured to perform one or more backend service functions 400, including a) collect messages, such as email messages that may include messaged value 405, b) parse messaged content, such as text content, content that can be converted to or extracted text, or both, 410, c) identify messaged value item 415, such as through text analysis, object recognition, user verification, or the like, d) categorize messaged value item 420, such as through associating the message value item with attribute values, by creating a relationship in a data store between a category and a unique message identifier, and the like, e) parameterize messaged value item 425, such as creating attribute values in a data store associated with the message, where those attribute values are extracted directly from the messaged content, header, or metadata, derived from the messaged content, header, or metadata, or the like, f) receive requests for messaged value 430, such as a request received by a services endpoint, g) retrieve one or more potentially matching messaged value items 435, where a received request for messaged value includes one or more matchable messaged value attributes, h) return one or more messaged value items 440, i) update one or more messaged value attributes 445, such as expiration, validity, parameters, categories, use count, transferability, and the like, j) receive attribute update 450, such as from a requestor, such as a messaged value application component resident on a device 105, and (k) update one or more messaged value attribute 455, such as expiration, validity, parameters, categories, use count, transferability, and the like.

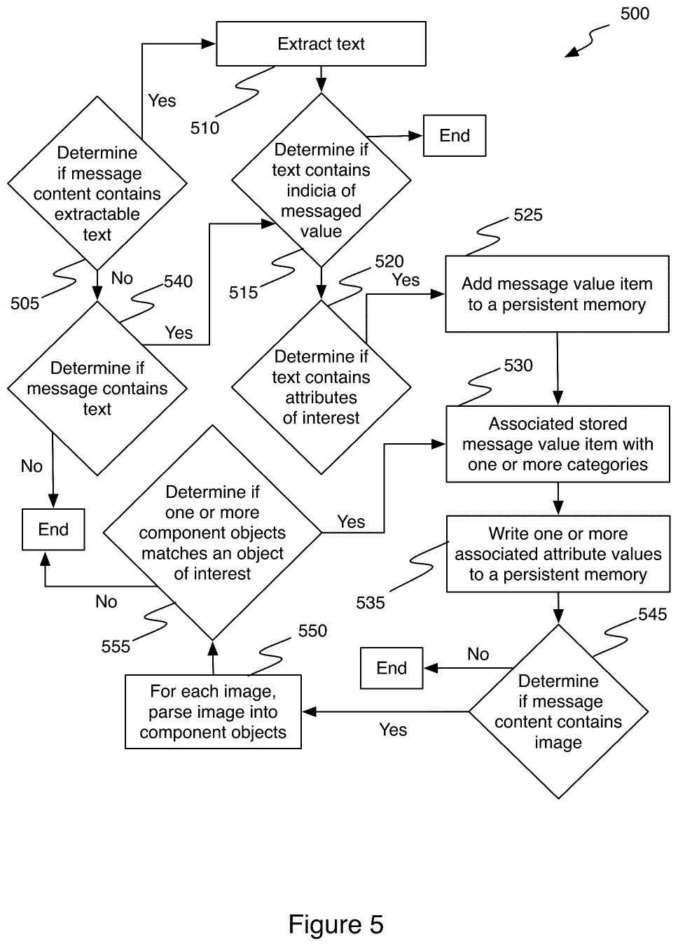

Referring now to FIG. 5, in some embodiments, the messaged value retrieval and management system makes determinations related to messaged value included in messaged content 500. A determination can be made whether or not a message contains messaged content that includes extractable text 505. In some implementations, this is accomplished by identifying non-text elements, and passing these elements to a text extraction service, and attempting to extract any text content 510. Once extracted, the extracted text can be analyzed to determine whether it contains any indicia of messaged value 515, and further, whether the text contains attributes of interest. This can be accomplished through the use of text analysis technologies. Similarly for messaged content that is available without extraction 540, the same two-part analysis can be applied 515, 520.

In some implementations, if messaged value is identified, a messaged value item is created in persistent memory that represents the message value 525, where the messaged value item can be further categorized 530 and parameterized, such as by writing one or more associated attribute values to a persistent memory 535. Messaged content can be further analyzed to determine whether image content is present 545, and where it is, images can be processed where image portions are isolated 550 as objects to be compared against stored objects of interest to determine a degree of matching 555. The prior described two-part analysis can then be applied 515, 520.

In some embodiments, messaged value items are associated with one or more attributes, such as by one or more of brand, domain, product or service, value amount, expiration, transferability, allowed use count, and the like. This attribute value association can increase accuracy and timeliness when automatically transmitting, presenting, and applying valid, available, and applicable offers of messaged value at the time of relevant device activity events. In some instances, offers of messaged value can include, for example, discount offers, credit offers, additional product or service offers, and the like. In some instance, additional associated derivative attribute values are written to the persistent data store, such as, whether the messaged value amount is exceeds a minimum threshold value.

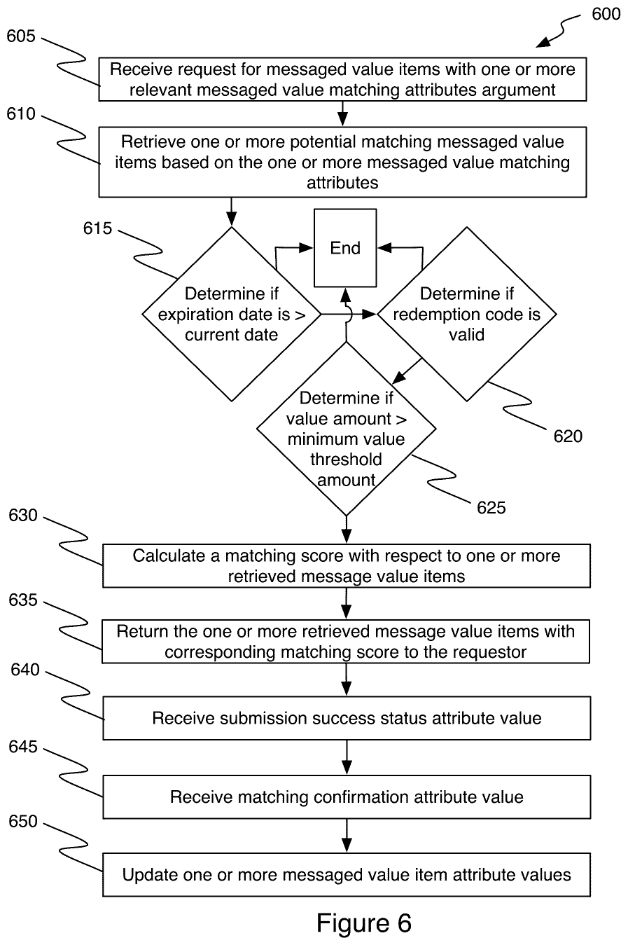

Referring now to FIG. 6, in some embodiments, messaged value item requestor communications are handled 600 by one or more messaged value retrieval and management system services 205, 210, 215. In some implementations, a request for messaged value item is received, such as via a call to a messaged value retrieval and management system services endpoint available via an API gateway, where such call includes one or more relevant messaged value matching attributes arguments 605. Messaged value matching attributes argument values can include, for example, information identifying a brand, company, domain, subdomain, URL, page, product, image, or other information, data, or content that can serve as a source for comparison in determining whether a messaged value item matches the requestor state with respect to the application of a potential messaged value item. Potential matching messaged value items can be retrieved 610, and based on one or more comparison operations, depending at least in part on the type of information, data, or content received, the messaged value retrieval and management system services 205, 210, 215 perform one or more comparison operations to identify potential matching messaged value items. In some implementations, a matching score is determined 630, such as, for example, a confidence score, indicative of a degree of confidence with respect to the probability of the matching messaged value item being usable, such as for making a purchase or other redemption.

In some instances, one or more pre-defined threshold determinations are performed with respect whether the messaged value meets the one or more pre-defined thresholds, either in advance of, during, or subsequent to the performance of the comparison operations. Such determinations can include, for example, whether or not a messaged value item is potentially expired, such as by comparing an expiration date attribute value to the current date 615, whether the value amount of a messaged value item exceeds a pre-determined minimum threshold value 625, and optionally, whether a redemption value, such as a redemption code is a valid redemption code, such as by communicating with a vendor or supplier of the code to determine prior to transmitting the messaged value item whether or not the code will be accepted at a purchasing event 620. In some instances, one or more cleanup mechanisms either segregate or remove one or more of the messaged value items or corresponding message where one or more of the threshold determinations return false. Additional threshold determinations can include, for example, domain of interest, brand of interest, product or service of interest, and the like.

Where at least one messaged value item is retrieved, one or more of the messaged value items can be marshalled, formatted, and returned to the messaged value item requestor, such as a response to the call to the messaged value retrieval and management system services endpoint 635. In some instances, the messaged value item services continue to receive information and updates from the messaged value item requestor such as, for example, the success or failure status of the application of the messaged value item at a purchase event 640 and confirmation of the correctness of the matching status or confidence value for one or more of the transmitted message value items 645. In some implementation, this received information and updates are used to update one or more persistent messaged value item attribute values 650, such as a messaged value item use count attribute value, a messaged value item validity attribute value, a matching accuracy verification value, or the like.

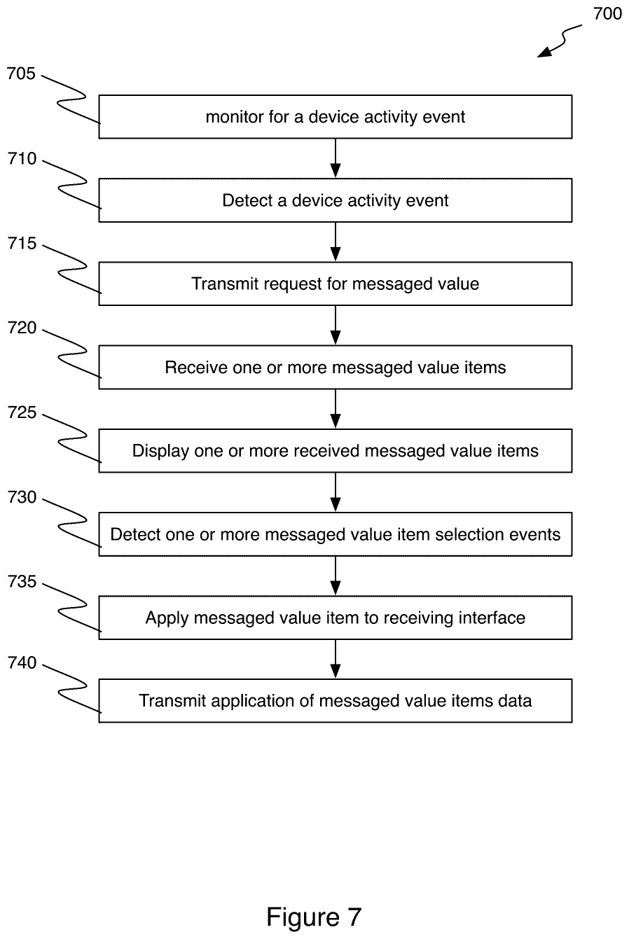

Referring now to FIG. 7, in some embodiments, the messaged value retrieval and management system includes a messaged value application component 110 that can perform monitoring and application processes 700 including one or more of a) monitor for a device activity event 705, such as the browsing, accessing, or otherwise interacting with an internet location, such as a domain, subdomain, page, a page or app interaction with a purchase-related element, such as company, brand, or product, or the like, b) detect a device activity event 710, c) request messaged value items 715, such as by making a call to a service endpoint that includes one or more activity or other messaged value attributes as an argument, c) receive messaged value items 720, such as a messaged value item with potential matching to a possible purchase event, e) display received messaged value items 725, such as displaying the received message value items in a message value item selection view prior to are at the time of a purchase event, f) receive messaged value item selections 730, such as user interface selection of a messaged value item that is appropriate for a possible purchase event, g) apply messaged value items to receiving interfaces 735, such as by auto-populating a form, a redemption code interface, or the like, and h) transmit data associated with the application of messaged value items 740, such as transmitting successful application, validity errors, usage count, satisfaction measures, and the like, to the messaged value retrieval and management system services.

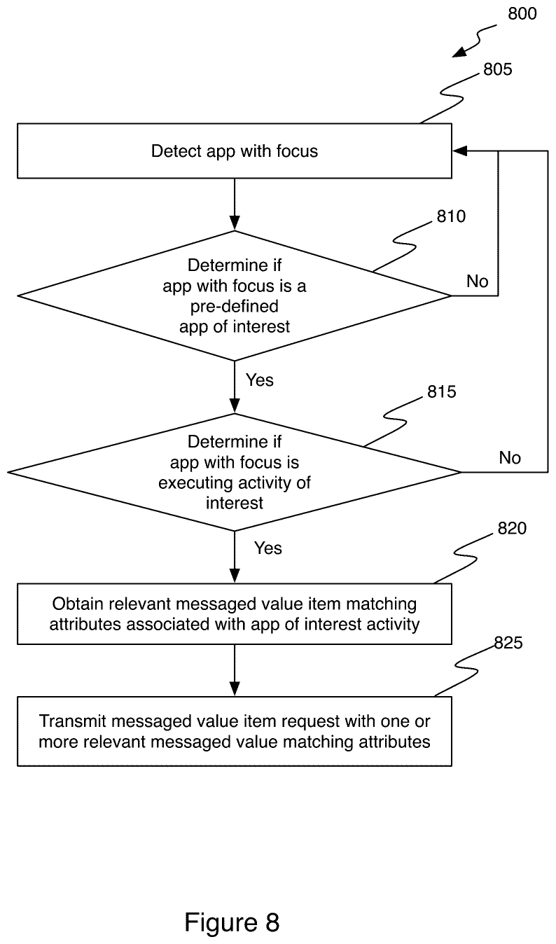

Referring now to FIG. 8, in some embodiments, a messaged value application component monitors certain activities and events, such as device activities, app activities, and app events, as part of detecting candidate activities for application of a matching messaged value item 800. In some instances, app focus is monitored overtime 805, such as either near-constantly or intermittently, determining, at least in part, the app currently in use. The identified app with focus can then be compared against a pre-defined list of apps of interest 810. Such list can include a user identified apps of interest, one or more apps compatible with the automation of redemption code submission, apps that typically include purchase events, and the like. Further monitoring can include detection of an app of interest performing an activity of interest 815, such as, for example, browsing pages with potential for purchasing events, a page or view containing form fields indicative a purchasing event, or the like. In some implementations, one or more relevant messaged value item matching attributes associated with app of interest activity are obtained 820, such as through scraping, html parsing, image capture, and the like. The collected attributes can then be transmitted 825 to a messaged value retrieval services endpoint as arguments with a messaged value item request.

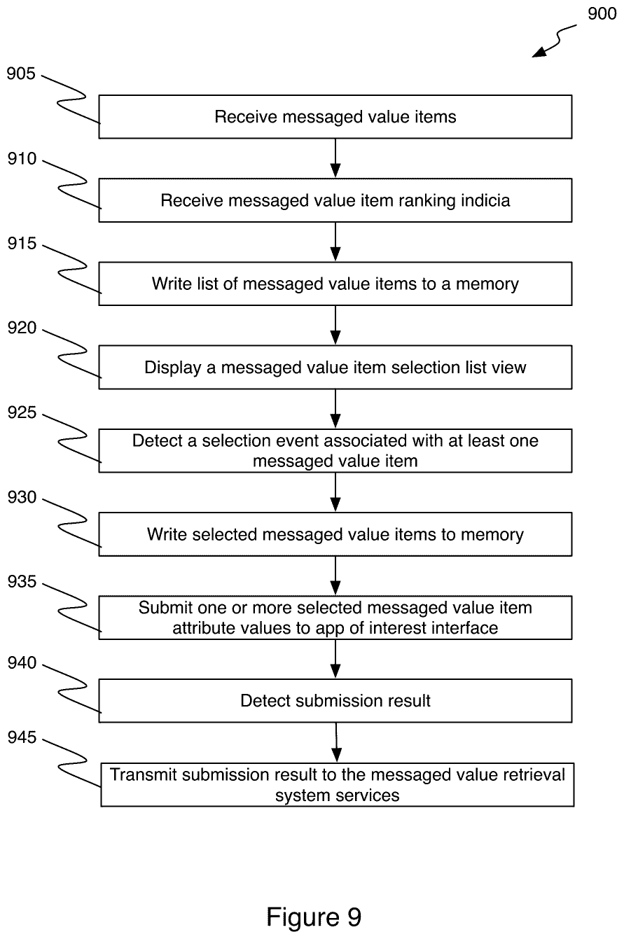

Referring now to FIG. 9, in some instances, messaged value items are applied at the time of an applicable activity or event 900. In some embodiments, a messaged value application component receives one or more message value items 905, associated message value ranking indica 910, such as confidence scores, or other information or data useful to the application and redemption of the messaged value item. Where multiple messaged value items are received, the messaged value application component can generate an ordered list 915 for possible ordered automated application of messaged value items to a purchase event, allowing for sequential attempts based on, for example, ordered confidence scores. In some instances, the list of messaged value items is displayed in a selection view 920. Selection events can be detected 925 with selected message value items and associated attribute values can be written to memory 930 in support of applying selection to events, such as a purchase event.

In some instances, one or more selected messaged value item attribute values are submitted to an app of interest interface 935 such as through automated detection of an applicable form, auto completion of one or more form fields, such as a redemption code field. In some instances, submission is semi-automated by facilitating the ease of population and submission of messaged value item attribute values, such as through copy and paste. In some implementations, the messaged value application component communicates one or more values to the messaged value retrieval and management system services 940, 945, such as, for example, the success or failure status of the application of the messaged value item at a purchase event, confirmation of the correctness of the matching status or confidence value for one or more of the transmitted message value items, validity errors, usage count, satisfaction measures, and the like.

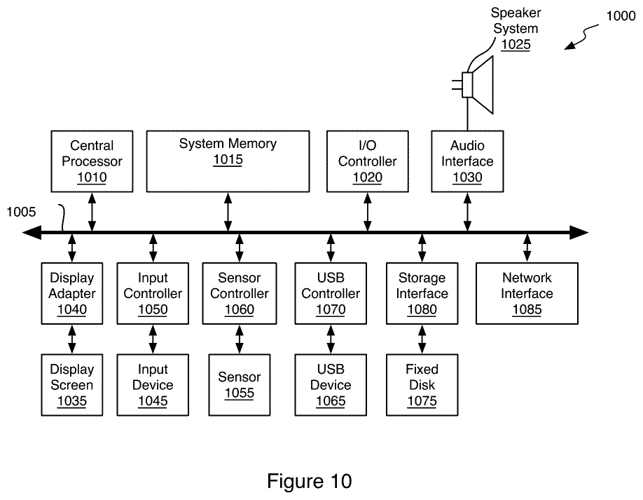

Referring now to FIG. 10, in one configuration, the messaged value retrieval and management system devices 1000 include one or more of a bus 1005 which interconnects major subsystems of computing device, such as a central processor 1010, a system memory 1015 (typically RAM, but which may also include ROM, flash RAM, or the like), an input/output controller 1020, an external audio device, such as a speaker system 1025 via an audio output interface 1030, an external device, such as a display screen 1035 via display adapter 1040, an input device 1045 (e.g., remote control device interfaced with an input controller 1050), one or more peripheral devices 1065, such as devices interfaced with a USB controller 1070), and a storage interface 1080. In some instances, the computing device includes one or more sensors 1055 connected to bus 1005 through a sensor controller 1060 and a network interface 1085 (coupled directly to bus 1005). In some implementations, the computing device is integrated with one or more of a camera, a scanner, a sensing technology, a measurement technology, or the like. In some instances, sch integrated components are onboard, while in other cases, such integrated components are attached and interfaced as peripheral devices.

Bus 1005 allows data communication between central processor 1010 and system memory 1015, which may include read-only memory (ROM) or flash memory (neither shown), and random-access memory (RAM) (not shown), as previously noted. The RAM is generally the main memory into which the operating system and logic instructions are loaded. The ROM or flash memory may contain, among other code, the Basic Input-Output system (BIOS) which controls basic hardware operation such as the interaction with peripheral components or devices. Instructions resident with the messaged value retrieval and management system computing devices are generally stored on and accessed via a non-transitory computer readable medium, such as a hard disk drive (e.g., fixed disk 1075) or other storage medium. Additionally, applications may be in the form of electronic signals modulated in accordance with the application and data communication technology when accessed via interface 1085.

Storage interface 1080, as with the other storage interfaces of controller 1000, may connect to a standard computer readable medium for storage and/or retrieval of information, such as a fixed disk drive 1075. Fixed disk drive 1075 may be a part of computing device 1000 or may be separate and accessed through other interface systems. Network interface 1085 may provide a direct connection to a remote server via a direct network link to the Internet via a POP (point of presence). Network interface 1085 may provide such connection using wireless techniques, including digital cellular telephone connection, Cellular Digital Packet Data (CDPD) connection, digital satellite data connection, or the like. In some embodiments, one or more sensors, scanners, measurement devices, or sensing devices connect to computing device 1000 wirelessly via network interface 1085. In some embodiments, the system is integrated with peripheral devices, either wired, wirelessly, or embedded.

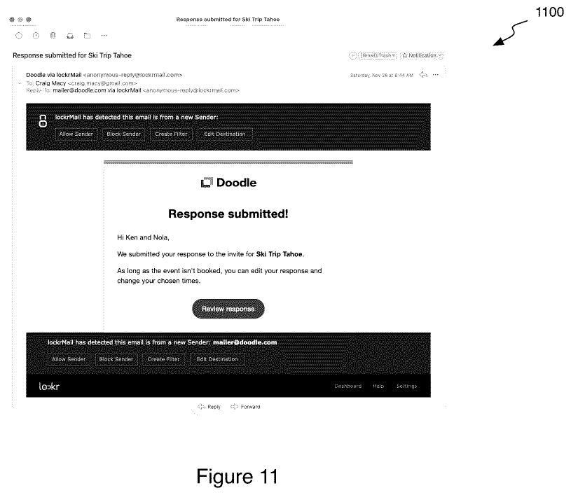

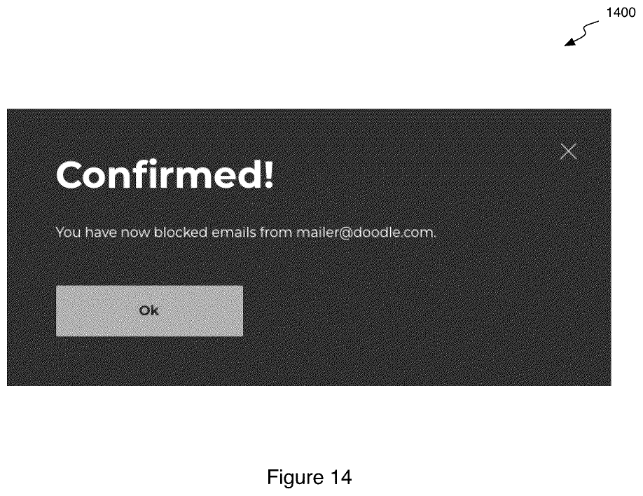

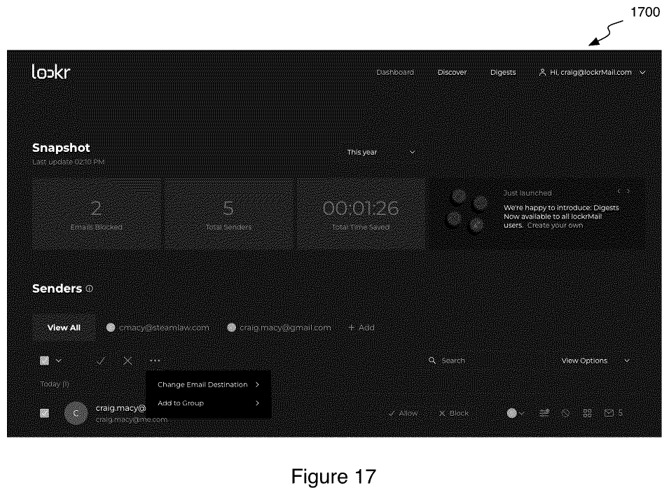

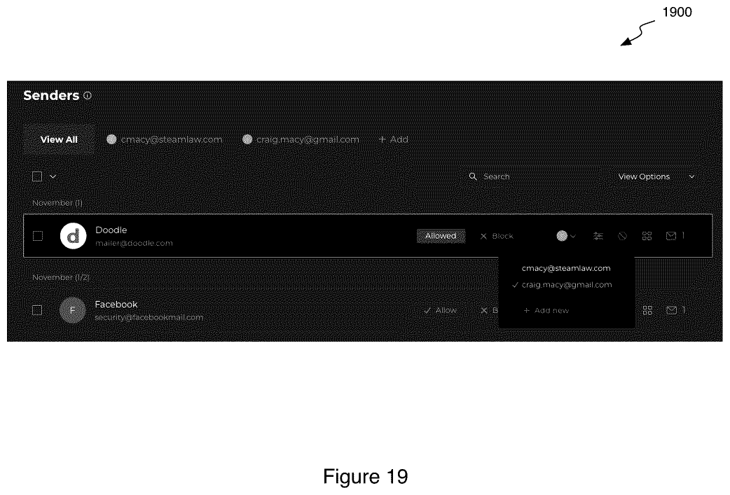

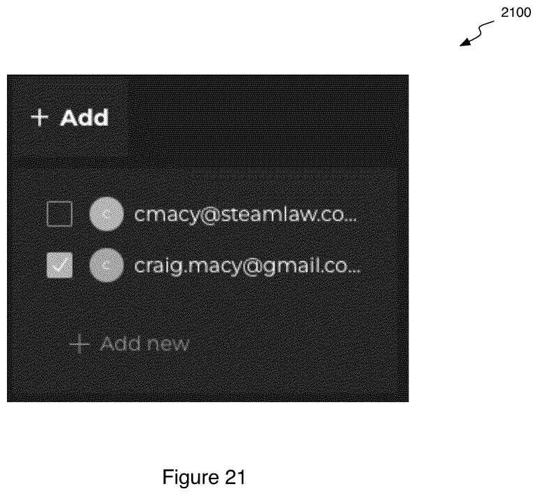

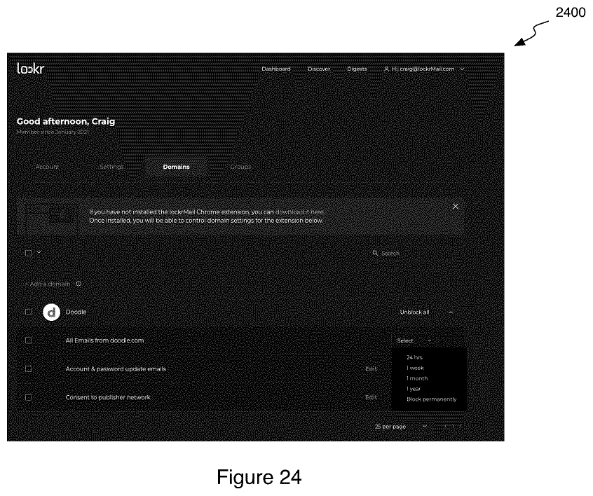

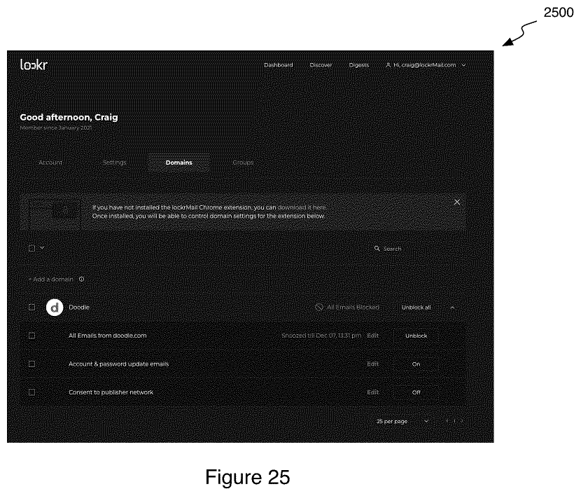

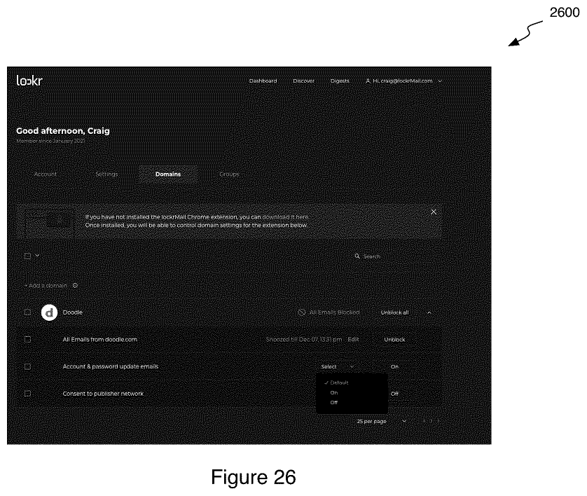

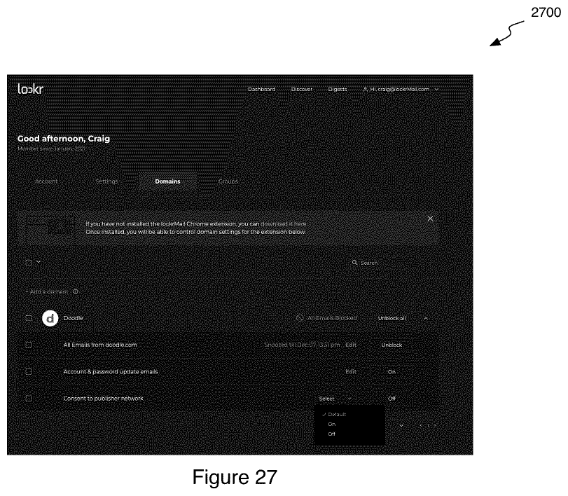

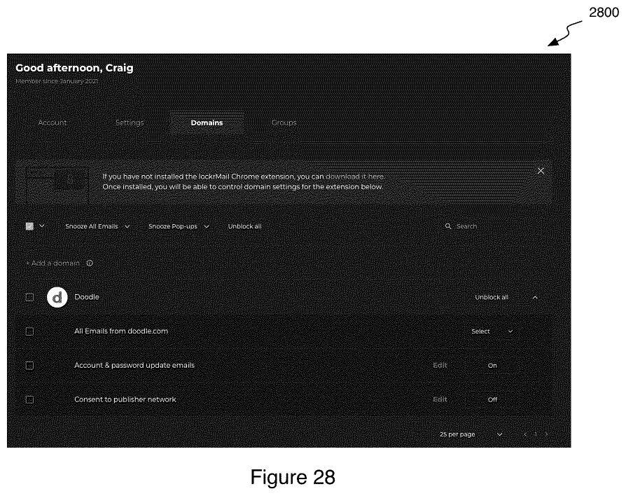

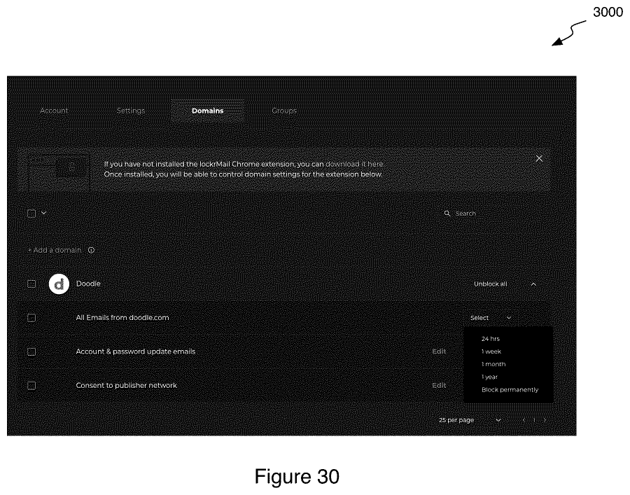

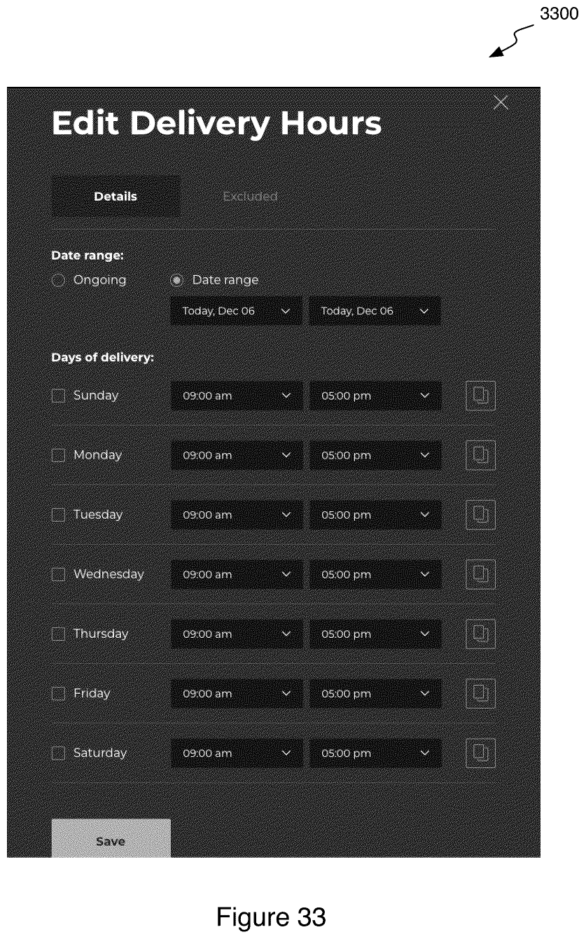

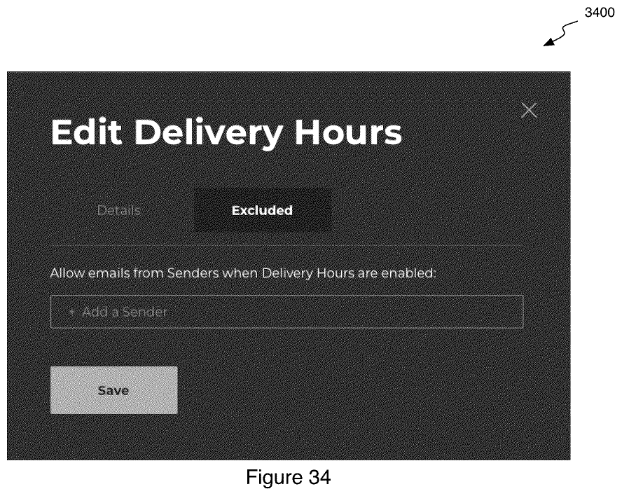

Referring now to FIG. 11 through FIG. 35, in some embodiments, one or more of off-account processing, transmission, and storage of messaged value is configurable via multiple configurable parameter interfaces.

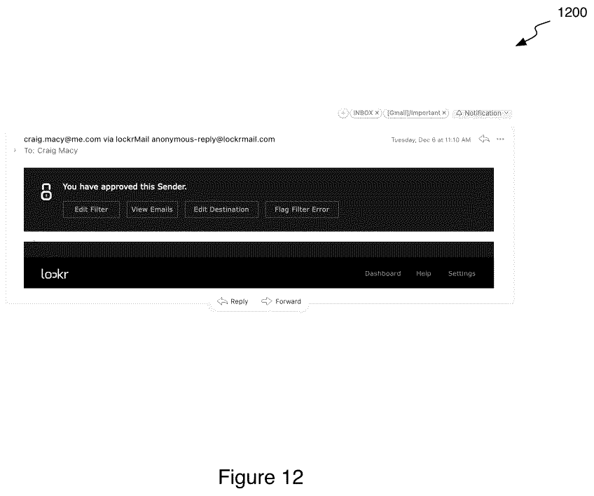

Referring now to FIG. 11 and FIG. 12, in certain implementation, one or more email application interfaces provides access to one or more messaged value system services 205, 210, 215 configuration settings. For example, when distributing messaged value content to an email application, the messaged value content can be in the form of an email with an email header, such as an email header with interface controls. In some instances, for messaged value content that originated from a content source not currently under messaged value retrieval and management system configuration control, interfaces can include, but are not limited to, an Allow Sender control, a Block Sender control, a Create Filter control, and an Edit Destination control. Some implementations for messaged value content that originated from a content source currently under messaged value retrieval and management system configuration control, interfaces can include, but are not limited to, an Edit Filter control, a View Emails control, and an Edit Destination control.

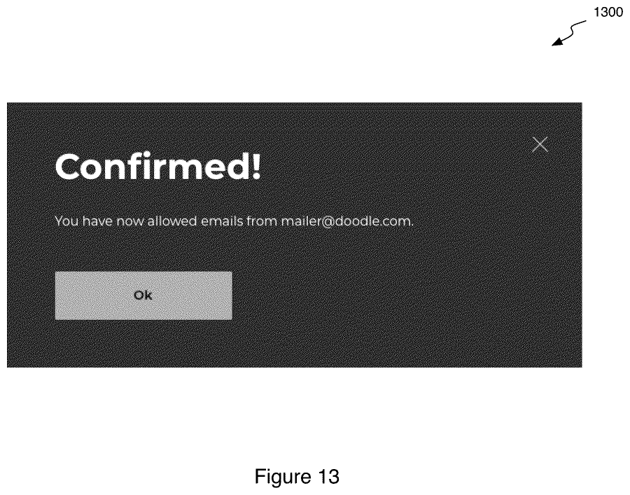

Referring now to FIG. 13 through FIG. 17, in some embodiments, one or more configuration interfaces are initiated in response to an email header control detection event. For example, the detection of a click event associated with an Allow Sender control can transmit a message to a component of the messaged value management service layer 215 directing the messaged value retrieval and management system to allow for the distribution of future messages from the identified sender, communicating back to the email wrapper component from the core services layer 205 to present an allow sender confirmation message. Similarly, the detection of a click event associated with a Block Sender control can transmit a message to a component of the messaged value management service layer 215 directing the messaged value retrieval and management system not to distribute future messages from the identified sender, communicating back to the email wrapper component from the cores services layer 205 to present a block sender confirmation message.

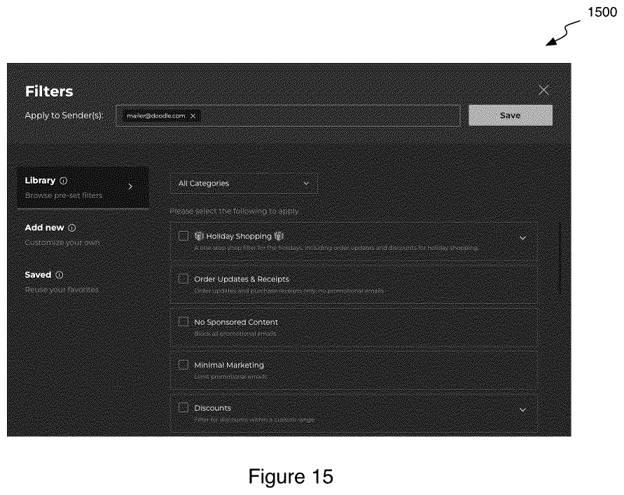

Referring now to FIG. 15, in some instances, the detection of a click event associated with Create Filter email wrapper control can transmit a message to a component of the messaged value management service layer 215 directing the messaged value retrieval and management system to proceed with the creation of a configurable distribution filter.

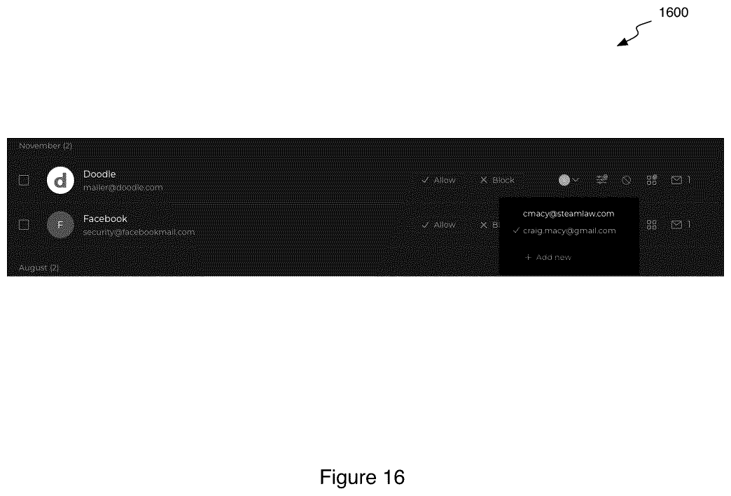

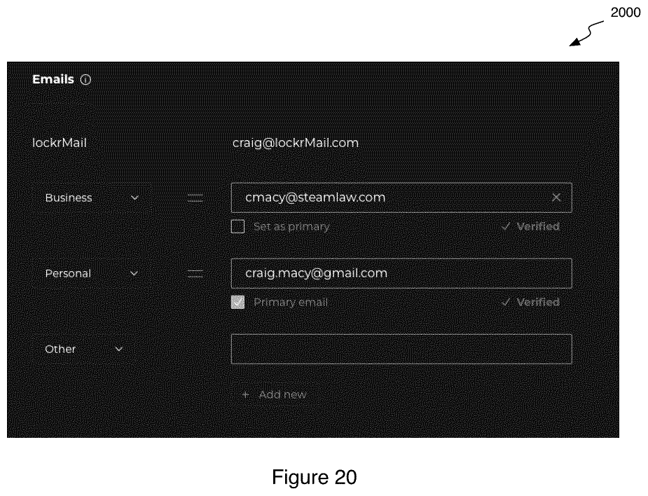

Referring now to FIG. 16 through FIG. 21, the detection of a click event associated with an Edit Destination email wrapper control can display an interface to configure one or more email account destinations for the distribution of future emails associated with one or more of the identified sender, sender's domain, and applicable filters. In some instances, these email destination accounts can include one or more existing email accounts, new email accounts, or both. Referring now to FIG. 20, in certain implementations, multiple available email destination accounts can be added, including categorization metadata, primary indicators, and the like.

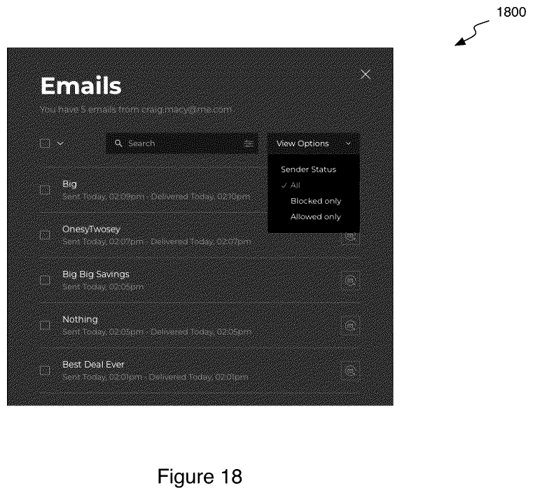

Referring now to FIG. 18, in certain embodiments, the detection of a click event associated with a View Emails email wrapper control can direct the messaged value retrieval and management system to retrieve one or more previously collected mail messages of the identified sender. This displayed interface can further include configurable display options, such as, for example, some or all of email, blocked email, allowed email, and the like. This display interface can also include the ability to select one or more previous email for distribution to the associated email destination account.

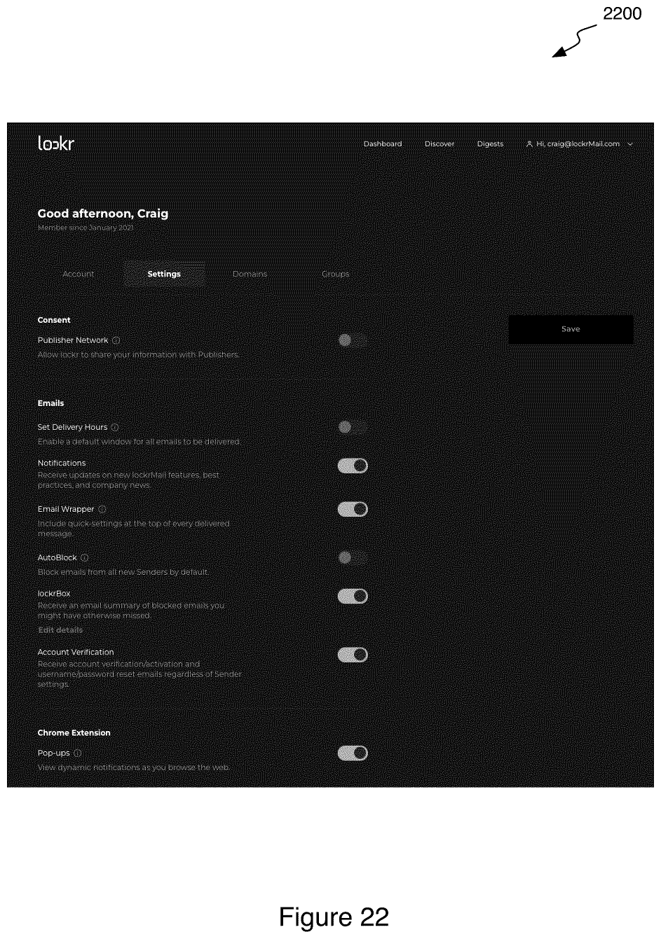

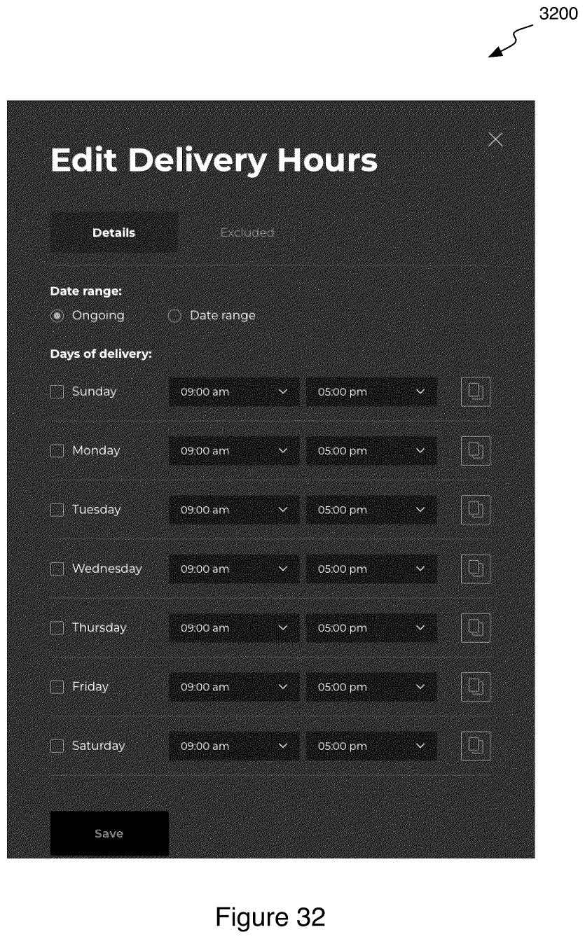

Referring now to FIG. 22, one or more off-account processing, transmission, and storage settings can be configurable via a setting interface view. Configurable settings can include one more of, but are not limited to, consent settings, email settings, and messaged value application component 220 settings. Consent settings can include, for example a Publisher Network setting that enables the sharing of information with publishers. Email setting can include, for example, delivery hours (e.g., see FIG. 32 through FIG. 34), notifications, email wrapper enablement, autoblocking, blocked email summary distribution, and enhanced account verification. In some instances, one or more messaged value application components 220 can be enabled or disabled.

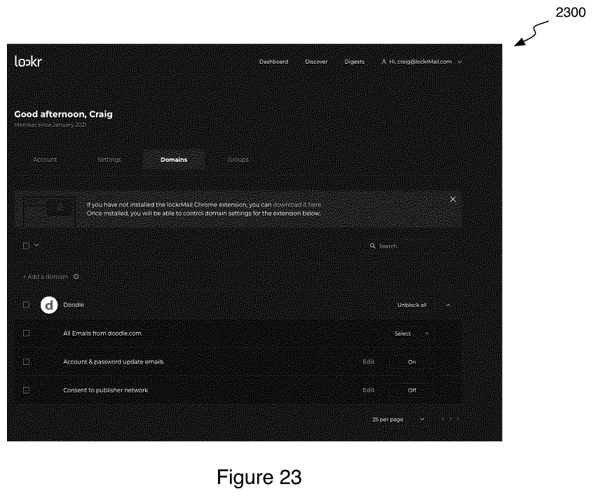

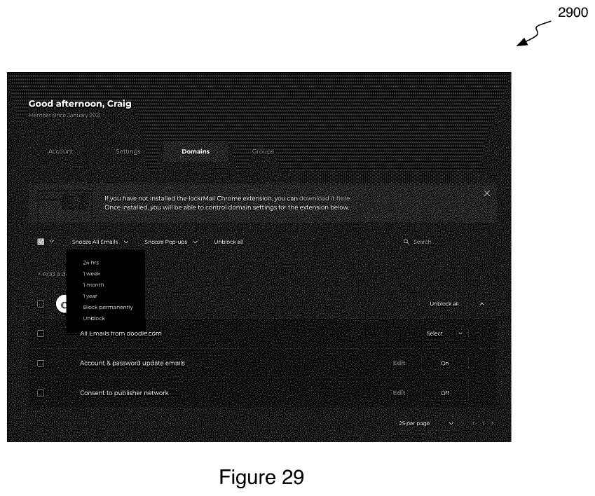

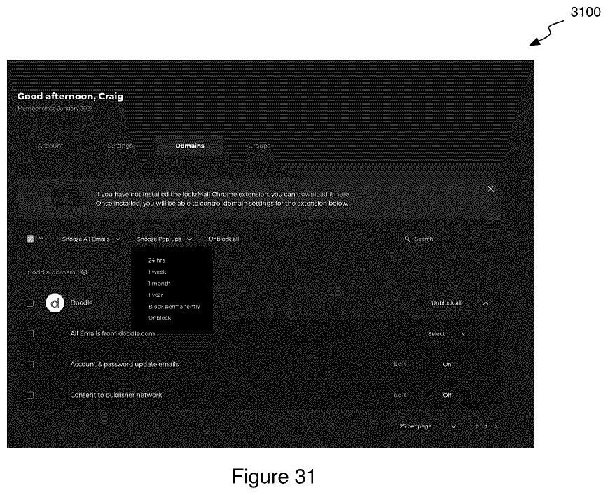

Referring not to FIG. 23 through FIG. 31, distribution of messaged value content can be conditioned upon domain-related attributes. This can include, for example, one or more of blocking distribution of all domain-related content within a defined window of time, blocking notification, such as browser notifications, of all domain-related content within a defined window of time, blocking domain-related account and password update emails, and providing consent to share information with a publisher network. Referring now to FIG. 18, FIG. 29, and FIG. 31, in some implementations, you can set domain-related configuration attributes in bulk across multiple domains simultaneously.

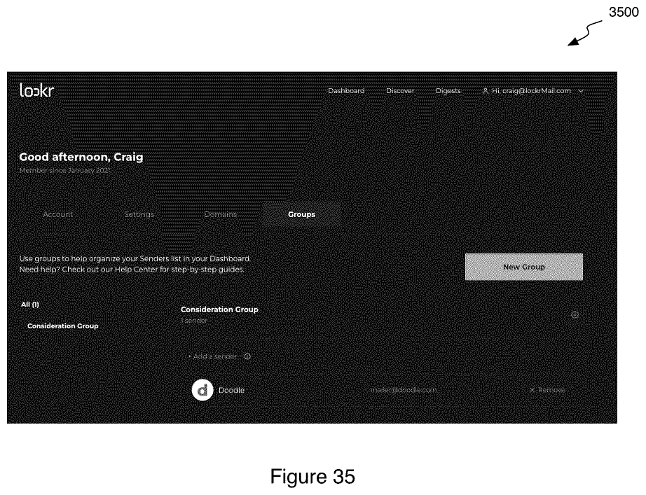

Referring now to FIG. 35, in some embodiment, an interface is provided for the creation of groups, where such groups can serve to organize senders list on the main dashboard. By creating custom groupings of senders to, for example allow for easier sorting and application of bulk actions across multiple senders.

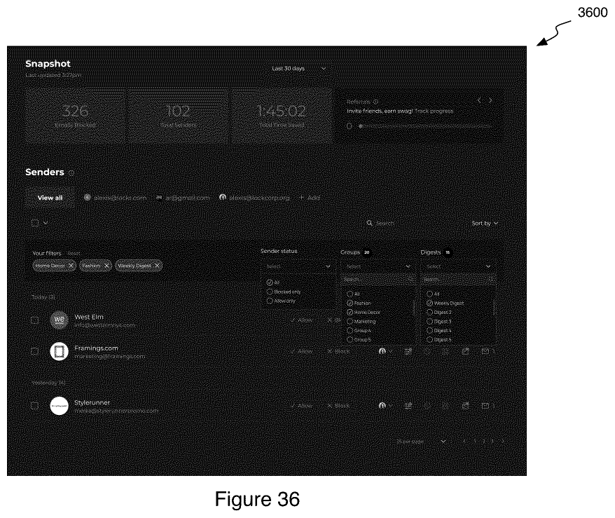

Referring now to FIG. 36, in certain embodiments, multiple statistics and configuration parameters are displayed and made accessible, including, for example, a listing of recently-received content and the parameters available for configuring the treatment of such present and future content.

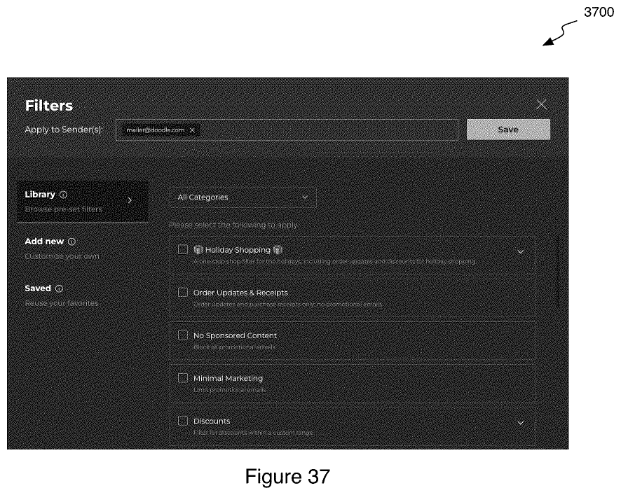

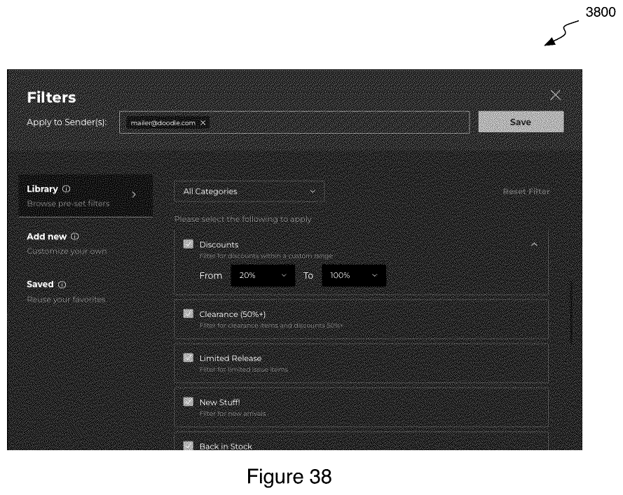

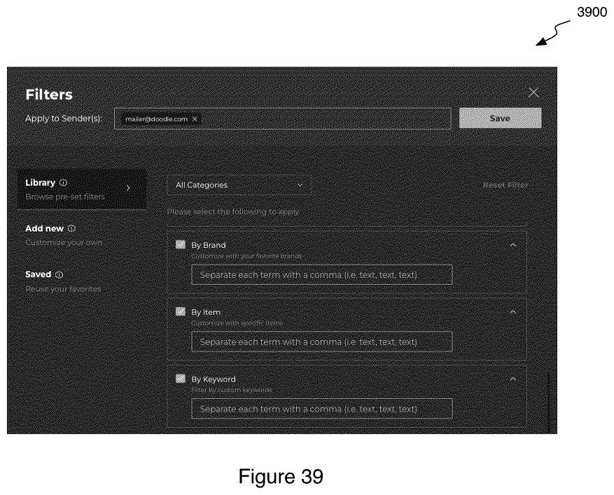

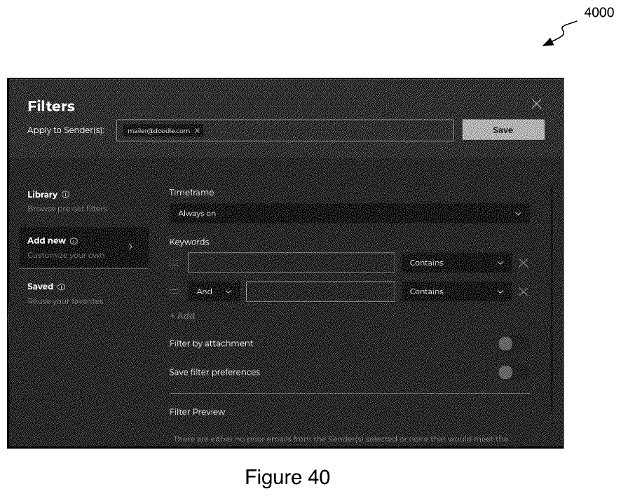

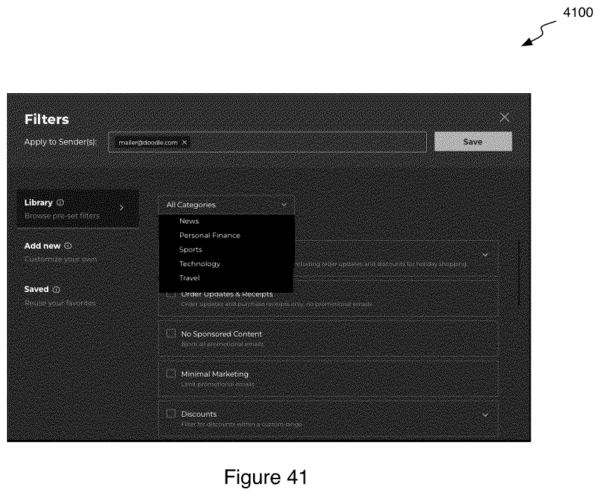

Referring now to FIG. 37 through FIG. 41, in some instances, off-account content filtering by the message management service 210 can be configured to control various aspects of content distribution. For each sender, distribution of a subset of content, such as emails, can be controlled, at least in part, through configuration of one or more filters. In certain implementations, a filter library includes pre-defined filters. The filter library can include a variety of automated settings that can streamline the filtering process and provide single-select access to robust filtering logic. Pre-defined filters can include, one or more of, for example:

A) An order updates filter appropriate for, among other things, regularly ordered or purchased retail brands where, for example, there is desire to prevent distribution of additional marketing content. This can exclude, for example, order updates, such as order summaries, shipping notifications, tracking updates, delivery notices, and the like. An example of this filter logic is:
“((contains” “order” “) AND (Update OR Delivered OR Delivery OR Payment OR Status OR Shipped OR Confirmed OR Confirmation OR Summary OR Scheduled OR Tracking OR Track OR Date)) OR
((contains Confirmation) AND (Update OR Delivered OR Delivery OR Payment OR Status OR Shipped OR Summary OR Scheduled OR Tracking OR Track OR Date)) OR
((contains Track) AND (Update OR Delivered OR Delivery OR Payment OR Status OR Shipped OR Confirmed OR Confirmation OR Summary OR Scheduled OR Date)) OR
(contains ‘receipt from’) OR
(contains ‘receipt settings’) OR
(contains ‘order confirmation’) OR
(contains ‘payment processed’ and ‘total’)
and totally not contains ‘order by’, not contains ‘payments’
the matching keywords(eg: “ ” order “ ” and ‘update’) should be inside 40 letters”

B) a sponsored content filter for use with, for example, newsletter subscriptions that send, occasionally or otherwise, separate sponsored emails from advertisers. By applying the sponsored content filter, receipt of daily or weekly news updates can continue, absent some or all advertising. An example of this filter logic is:
does not contain ‘Presented By’ AND
does not contain Sponsored AND
does not contain ‘Shop Now’ AND
does not contain ‘Shop Here’ AND
does not contain ‘Coupon Code’

C) a limited marketing filter for use with brands and ecommerce sites that send email, including substantial volumes of email, but where there is a desire to stay up to date, including where there is a lack of knowledge with respect to appropriate limiting items or keywords. This filter can limit the number of emails distributed each week by, for example, a given brand. The logic of this filter can, for example, be a simple percentage value where that value controls the threshold percent of emails distributed from a particular sender.

C) a discount filter can apply an upper discount threshold, a lower discount threshold, or both, to parsed email content, and block the distribution of emails outside the defined threshold range, while allowing for distribution when within that same range. The logic of this filter can be based on a conditional such as determining the embedded discount and comparing against a greater than value and less than value.

D) a clearance filter can restrict distribution of promotional emails to a defined discount threshold, as well as detect and condition distribution on one or more keywords, such as “Clearance” or “Half Off” or the like. An example of this filter logic is:
greater than 50% and contains clearance or contains half off

E) a limited release filter that allows for distribution of emails specifically announcing limited release products. An example of this filter logic is:
“(contains limited and (release or issue or stock or launch))
or (contains exclusive and (deal or deals or release or launch))
or (contains ““while supplies last””)”

F) a new arrivals filter that allows for the distribution of emails directed towards new arrivals of products or services. An example of this filter logic is:
(contains ‘Just Arrived’ OR ‘Just Dropped’ OR ‘New Arrivals’ OR ‘New Arrival’ OR ‘New Release’ OR ‘New Releases’ OR ‘Brand New’)

G) a back in stock filter that allows for distribution of emails directed to restocked item, which can work well for brands having items that regularly go out of stock. An example of this logic is:
Contains “back in stock” or “restocked”

H) an events filter that allows for distribution of event-oriented emails or senders, and in some instances, can be geographically limited. An example of this filter logic is: Contains “upcoming events” or “events schedule” or “event schedule” or “registration closing soon” or “registration is now open” or “book now” or “buy tickets” or “get tickets” or “event details” or “get your ticket now” or “registration confirmation” or “tickets attached”

I) a trip details filter that allows for the distribution of one or more of booking confirmations, schedule changes, and check-in reminders. An example of this filter logic is:
Contains “travel confirmation” or “trip details” or “confirmation #” or “booking confirmation” or “confirmation number” or modify reservation” or “cancel reservation” or “reservation confirmation” or “manage your stay” or “reservation details” or “flight recipt” or “time to check-in” or “prepare for your trip” or “eticket itinerary” or “upcoming trip” or “status update” or “flight receipt” or “new boarding” or “flight status update” or “schedule change” or “reservation is confirmed”

J) a socially conscious filter that allows for the distribution of eco-friendly and socially-conscious emails, such as newsletters, articles, blogs and news stories on. An example of this filter logic is:
Contains “socially conscious” or “eco-friendly” or “environmentally friendly” or “social impack” or “environment impact” or “sustainability” or “sustainable” or “socially responsible” or “environmentally responsible” or “corporate social responsibility” or “climate positive” or “carbon negative”

K) a brand filter that allows for the distribution of emails directed to or affiliated with certain identified brands. This filter logic can be based upon a set of keywords.

L) a by item filter that allows for the distribution of emails directed to or affiliated with certain identified items. This filter logic can be based upon a set of keywords.

M) a by keyword-based filter that allows for the distribution of emails directed to or affiliated with certain enumerated keywords. This filter logic can be based upon a one or more keywords, such as, for example, where the one or more keywords define a set of messages by one or more of:
By Source
By Room
By Sport
By Team
By Player
By Stadium
By Subject
By Age
By company
By Industry
By Destination
By Travel Style
By Travel Type
By Model
By Make
By Year
By Type (e.g., Used and New)
By Workout Type
By Diet
By Ingredient
By Restaurant
By Cuisine
By Location
By Events
By Recipient

In some embodiments, filters can be combined. Filtering logic can be implemented optimistically or pessimistically, where optimistic filtering uses logic to filter out and block emails that meet a condition from the set of all emails received, and where pessimistic filtering uses logic to filter emails for distribution that meet a condition from the set of all emails received. In some implementations, custom filters can be created based on one or more email attributes, including, for example, keywords, attachment state or content, and the like. In certain implementations, a dynamic filter preview displays one or more previously received emails that meet the filter criteria and would have been blocked, in the case of pessimistic filtering, or would have been distributed, in the case of optimistic filtering. In some embodiments, a new or modified filter can be applied to previously received emails in an optimistic manner such that any emails that would have been distributed had that filter been in place at the time of receipt will be distributed. In certain instances, filter types are categorized such that there are different available criteria selections based on the associated category. In some embodiments, custom filters can be manually or automatically promoted to a shared filter library. In some instances, a shared library filter can be updated such that all instances using that shared library filter manifest the modifications in their evaluations.

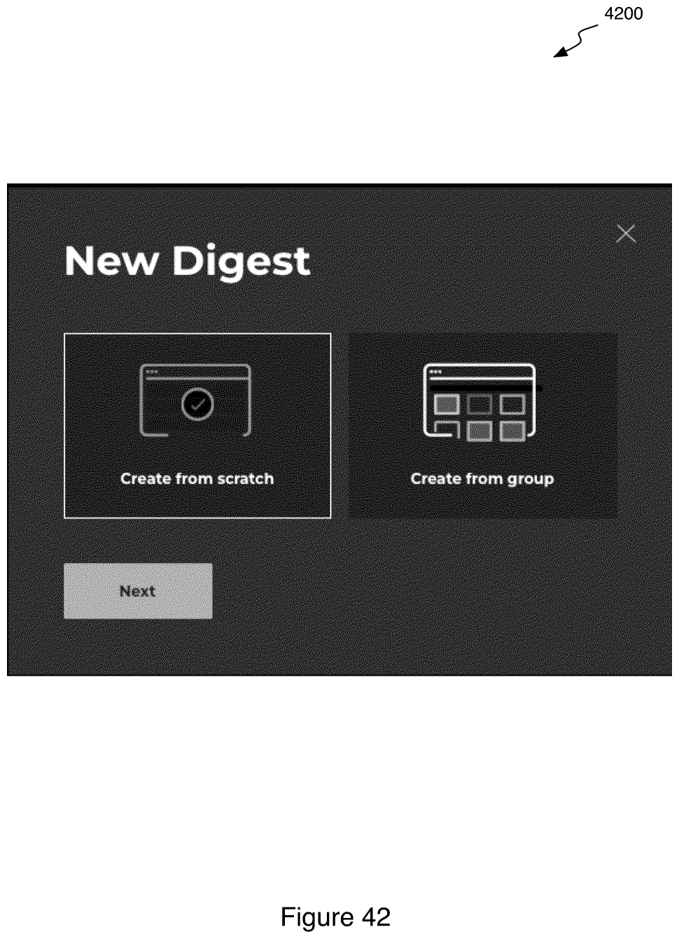

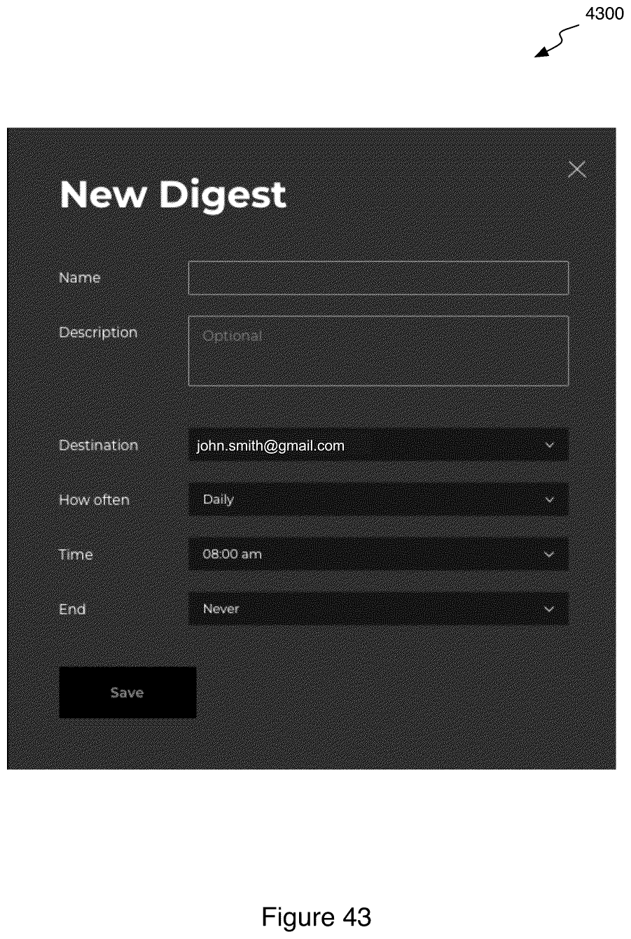

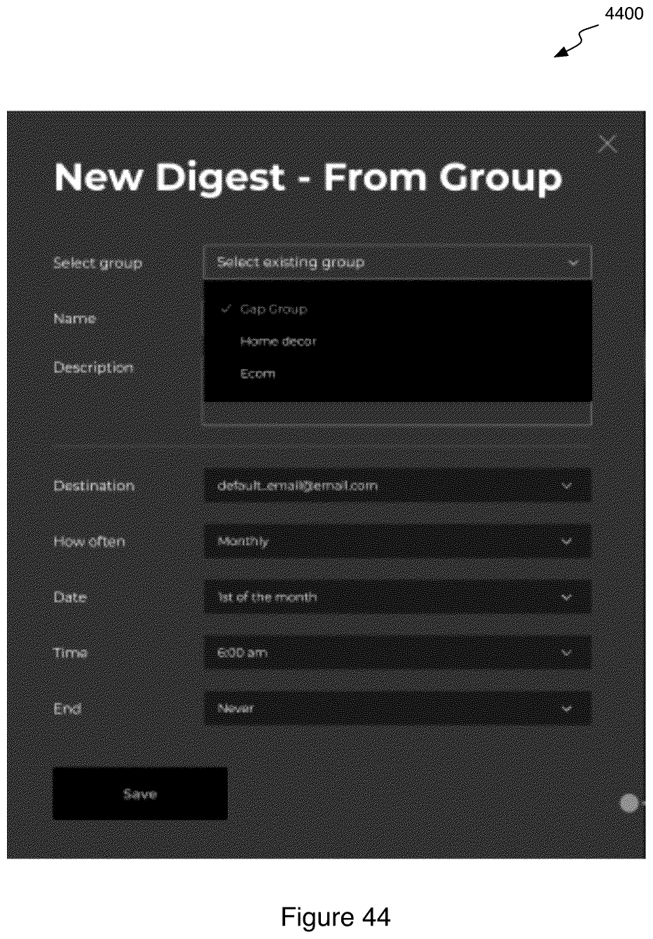

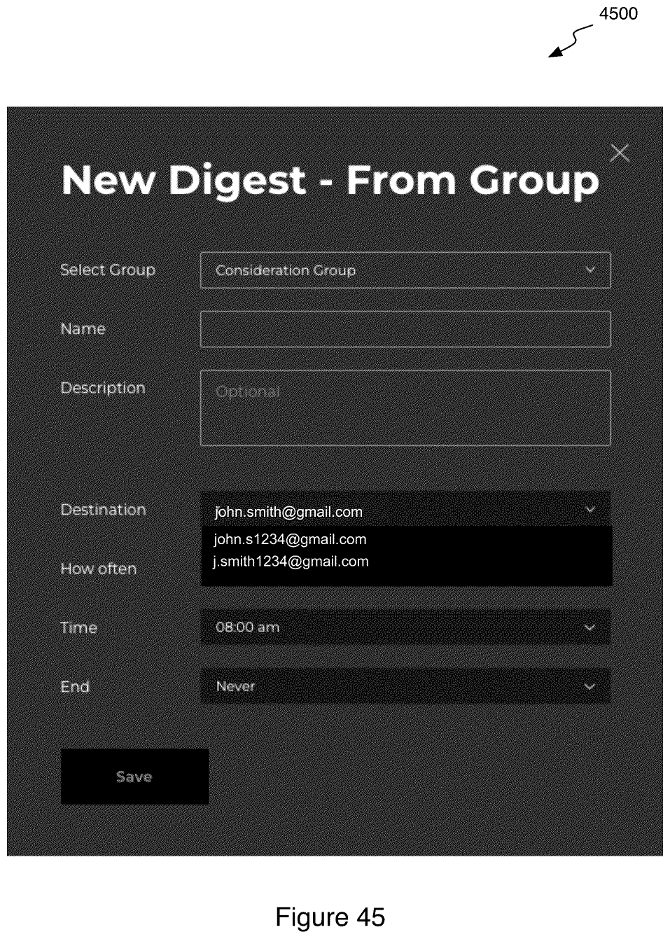

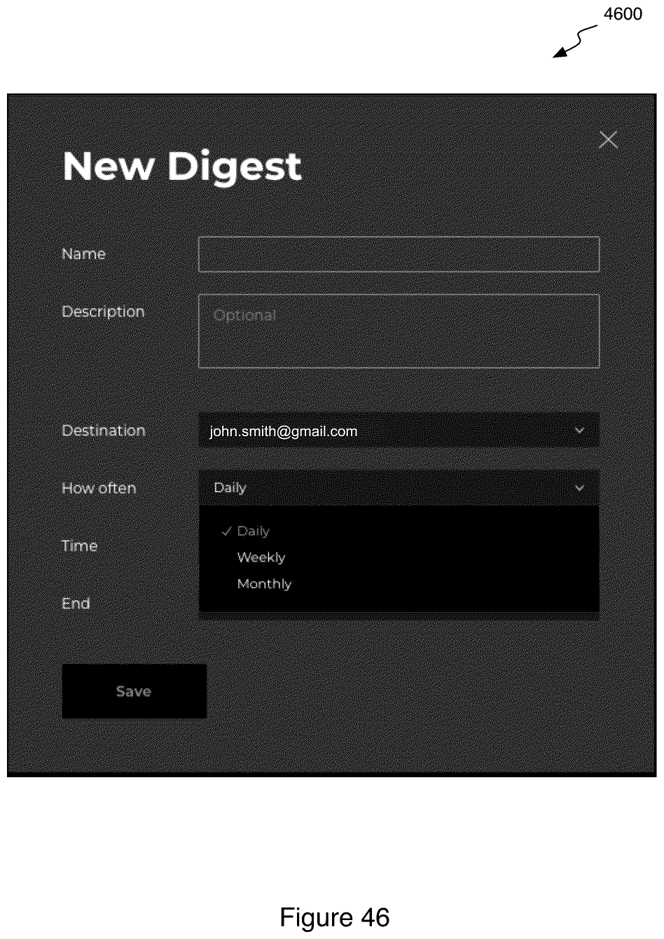

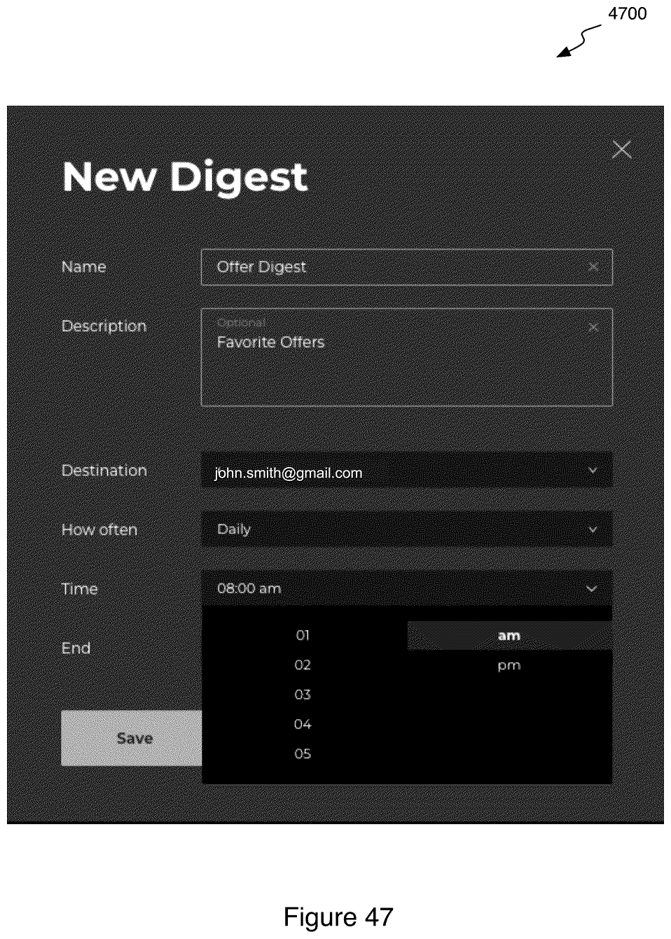

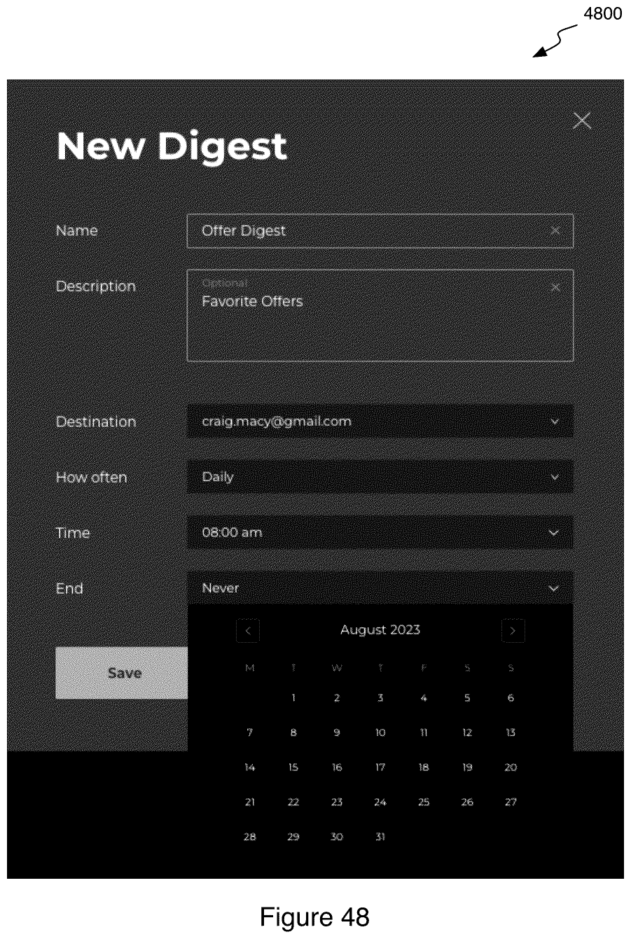

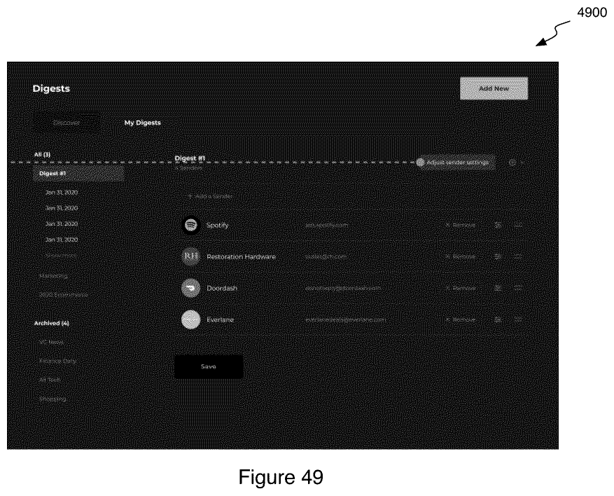

Referring now to FIG. 42 through FIG. 49, in some embodiments, the message value retrieval system includes the ability to aggregate emails, filter emails, or both, into a single message delivered at a defined frequency. This can be, for example, an aggregation of multiple newsletters, a single digest of item offers exceeding a certain threshold, or the relevant industry news. In each case, these can be delivered at a set time, such as each week on Sunday morning. This can provide a number of advantages, including the reduction of intermittent interruption allowing for improved focus, the organization and consolidation of related content in a table of contents like layout, the presentation of content within a single interface, and the ability to quickly and efficiently add additional senders or filters.

Clause 1. A computer implemented messaged value retrieval and management system comprising in combination: (i) a computing system comprising at least one server comprising: (a) at least one processor; (b) at least one computer memory; (c) at least one network interface; and (ii) an off-account filter service at the at least one server operable to perform content distribution control using off-account content filtering, the off-account content filtering comprising one or more configurable filters.

Clause 2. The computer implemented messaged value retrieval and management system of clause 1, wherein the one or more configurable filters comprises an order updates filter.

Clause 3. The computer implemented messaged value retrieval and management system of clause 1, wherein the one or more configurable filters comprises a sponsored content filter.

Clause 4. The computer implemented messaged value retrieval and management system of clause 1, wherein the one or more configurable filters comprises a limited marketing filter.

Clause 5. The computer implemented messaged value retrieval and management system of clause 1, wherein the one or more configurable filters comprises a discount filter.

Clause 6. The computer implemented messaged value retrieval and management system of clause 1, wherein the one or more configurable filters comprises a clearance filter.

Clause 7. The computer implemented messaged value retrieval and management system of clause 1, wherein the one or more configurable filters comprises a limited release filter.

Clause 8. The computer implemented messaged value retrieval and management system of clause 1, wherein the one or more configurable filters comprises new arrivals filter.

Clause 9. The computer implemented messaged value retrieval and management system of clause 1, wherein the one or more configurable filters comprises a back in stock filter.

Clause 10. The computer implemented messaged value retrieval and management system of clause 1, wherein the one or more configurable filters comprises an events filter.

Clause 11. The computer implemented messaged value retrieval and management system of clause 1, wherein the one or more configurable filters comprises a trip detail filter.

Clause 12. The computer implemented messaged value retrieval and management system of clause 1, wherein the one or more configurable filters comprises a socially conscious filter.

Clause 13. The computer implemented messaged value retrieval and management system of clause 1, wherein the one or more configurable filters comprises a brand filter.

Clause 14. The computer implemented messaged value retrieval and management system of clause 1, wherein the one or more configurable filters comprises a by item filter.

Clause 15. The computer implemented messaged value retrieval and management system of clause 1, wherein the one or more configurable filters comprises a by keyword-based filter.

Clause 16. The computer implemented messaged value retrieval and management system of clause 1, further comprising an off-account message collection service operable to collect email messages.

Clause 17. The computer implemented messaged value retrieval and management system of clause 1, further comprising an off-account messaged distribution service operable to distribute email messages.

Clause 18. The computer implemented messaged value retrieval and management system of clause 17, further comprising an off-account message collection service operable to collect email messages.

Many other devices or subsystems (not shown) may be connected in a similar manner. Conversely, all of the devices shown in FIG. 10 need not be present to practice the present systems and methods. The devices and subsystems may be interconnected in different ways from that shown in FIG. 10. The aspect of some operations of a system such as that shown in FIG. 10 are readily known in the art and are not discussed in detail in this application. Computer instructions to implement the present disclosure may be stored in a non-transitory computer-readable medium such as one or more of system memory 1015 or fixed disk 1075. The operating systems provided on computing device 1000 may be, for example, iOS™, ANDROID™, MS-WINDOWS™, UNIX™, LINUX™, OSX™, or another known operating system.

These computer program instructions can be stored in a computer-readable memory that can direct a programmable data processing apparatus to operate in a particular manner, such that the instructions stored in the computer-readable memory produce an article of manufacture including instruction means which implement the acts specified herein. The computer program instructions may also be loaded onto a programmable data processing apparatus to cause a series of operational steps to be performed on the programmable apparatus to produce a computer implemented process such that the instructions which execute on the computer or other programmable apparatus provide steps for implementing the acts specified herein.

The various illustrative logical blocks, modules, and algorithm steps described in connection with the embodiments disclosed herein can be implemented as electronic hardware, computer software, computing device firmware, or some combinations thereof. To clearly illustrate this interchangeability of hardware, software, and firmware, various illustrative components, blocks, modules, and steps have been described generally in terms of their functionality. Whether such functionality is implemented as hardware, software, or firmware depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and engines described in connection with the embodiments disclosed herein can be implemented or performed with a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The processor can be, for example, a microprocessor, processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software or firmware module executed by a processor, or in a combination of the two. A software or firmware module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. In the alternative, the processor and the storage medium can be discreet components.

Depending on the embodiment, certain acts, events, or functions of any of the methods described herein can be performed in a different sequence, can be added, merged, or left out all together (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially. Moreover, in certain embodiments, acts or events can be performed on alternate tiers within the architecture.

The systems and methods disclosed can be implemented in a digital processing environment. The present systems and methods can also run on different architectures that may include a LAN, WAN, stand-alone PC, stand-alone mobile device, a stand-alone, clustered, or networked computers, etc.

Computing devices of various types can connect to a remote server infrastructure via a network over a communication protocol, such as, for example, TCP/IP. All computing devices can pass information as unstructured data, structured files, structured data streams such as, for example, XML, structured data objects, and/or structured messages. Client computing devices may communicate over various protocols such as, for example, UDP, TCP/IP, and/or HTTPS.

Client computing devices and server computers provide processing, storage, and input/output devices executing logic instructions. Client computers can also be linked through communications network to other computing devices, including other client devices/processes and server computers.

In some embodiments, server computers run software to implement centralized persistent data storage and retrieval. The network can be a wide area network that is part of a remote access network, a global network (e.g., the Internet), a worldwide collection of computers, gateways that currently use respective protocols (TCP/IP, UDP, etc.) to communicate with one another, and the like.

Depending on the embodiment, certain acts, events, or functions of any of the methods described herein can be performed in a different sequence, can be added, merged, or left out altogether (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially. Moreover, in certain embodiments, acts or events can be performed on alternate tiers within the architecture.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures may be implemented to achieve the same functionality.

The process parameters and sequence of steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification are to be construed as meaning “at least one of.” In addition, for ease of use, the words “including” and “having,” as used in the specification, are interchangeable with and have the same meaning as the word “comprising.” In addition, the term “based on” as used in the specification is to be construed as meaning “based at least upon.”

What is claimed is:

1. A computer implemented messaged value retrieval and management system comprising in combination:
i. a computing system comprising at least one server comprising:
a. at least one processor;
b. at least one computer memory;
c. at least one network interface; and
ii. an off-account filter service at the at least one server operable to perform content distribution control using off-account content filtering, the off-account content filtering comprising one or more configurable filters.

2. The computer implemented messaged value retrieval and management system of claim 1, wherein the one or more configurable filters comprises an order updates filter.

3. The computer implemented messaged value retrieval and management system of claim 1, wherein the one or more configurable filters comprises a sponsored content filter.

4. The computer implemented messaged value retrieval and management system of claim 1, wherein the one or more configurable filters comprises a limited marketing filter.

5. The computer implemented messaged value retrieval and management system of claim 1, wherein the one or more configurable filters comprises a discount filter.

6. The computer implemented messaged value retrieval and management system of claim 1, wherein the one or more configurable filters comprises a clearance filter.

7. The computer implemented messaged value retrieval and management system of claim 1, wherein the one or more configurable filters comprises a limited release filter.

8. The computer implemented messaged value retrieval and management system of claim 1, wherein the one or more configurable filters comprises new arrivals filter.

9. The computer implemented messaged value retrieval and management system of claim 1, wherein the one or more configurable filters comprises a back in stock filter.

10. The computer implemented messaged value retrieval and management system of claim 1, wherein the one or more configurable filters comprises an events filter.

11. The computer implemented messaged value retrieval and management system of claim 1, wherein the one or more configurable filters comprises a trip detail filter.

12. The computer implemented messaged value retrieval and management system of claim 1, wherein the one or more configurable filters comprises a socially conscious filter.

13. The computer implemented messaged value retrieval and management system of claim 1, wherein the one or more configurable filters comprises a brand filter.

14. The computer implemented messaged value retrieval and management system of claim 1, wherein the one or more configurable filters comprises a by item filter.

15. The computer implemented messaged value retrieval and management system of claim 1, wherein the one or more configurable filters comprises a by keyword-based filter.

16. The computer implemented messaged value retrieval and management system of claim 1, further comprising an off-account message collection service operable to collect email messages.

17. The computer implemented messaged value retrieval and management system of claim 1, further comprising an off-account messaged distribution service operable to distribute email messages.

18. The computer implemented messaged value retrieval and management system of claim 17, further comprising an off-account message collection service operable to collect email messages.
